(19) United States
(12) Patent Application Publication
(10) Pub. No.: US 2024/0202514 A1
(43) Pub. Date: Jun. 20, 2024

(54) MIXED-MODE CROSSBAR ARRAYS AND ASSOCIATED METHODS

(71) Applicant: HUAWEI TECHNOLOGIES CANADA CO., LTD., Kanata (CA)

(72) Inventors: Armaghan ESHAGHI, Kanata (CA); Enxiao LUAN, Kanata (CA); Sreenil SAHA, Kanata (CA)

(73) Assignee: HUAWEI TECHNOLOGIES CANADA CO., LTD., Kanata (CA)

(21) Appl. No.: 18/590,427

(22) Filed: Feb. 28, 2024

Related U.S. Application Data
(63) Continuation of application No. PCT/CA21/51357, filed on Sep. 29, 2021.

(51) Int. Cl. G06N 3/067; G02B 6/125; G06N 3/065; G02B 6/12

(52) U.S. Cl. CPC G06N 3/0675; G02B 6/125; G06N 3/065; G02B 2006/12147

(57) ABSTRACT

Embodiments of the present disclosure generally provide for a method and apparatus for performing computations using mixed-mode memory elements having contents which are accessible via both optical and electrical interactions. In particular, an array of such elements are accessed through a “crossbar” array structure which includes both an optical crossbar array structure an electrical crossbar array structure. Applications to machine learning, e.g. neural network training, are also provided for.

### CROSS-REFERENCE TO RELATED APPLICATIONS

This application is a continuation of International Application No. PCT/CA2021/051357, filed on Sep. 29, 2021, entitled “Mixed-Mode Crossbar Arrays and Associated Methods”, which is hereby incorporated by reference in its entirety.

### FIELD OF THE INVENTION

This disclosure pertains generally to the field of photonic computing and in particular to crossbar array computing usable for example in machine learning and artificial intelligence applications.

### BACKGROUND OF THE INVENTION

The von Neumann (VN) architecture that has been widely adopted in modern computing systems was first presented in 1945 by von Neumann and others. For more than five decades, the flexibility of the ‘stored program’ VN architecture has driven exponential improvements in system performance. FIG. 1A illustrates a von Neumann (VN) architecture. The digital computer architecture, based on VN architecture 100, separates the central processor unit (CPU) from the storage device, as shown in FIG. 1B. So, data processing requires transporting the data between the memory and the processor, as shown for example via lines 102.

However, as device scaling has slowed due to power and voltage considerations, the time and energy spent transporting data across the so-called ‘Von-Neumann bottleneck’ between memory and processor, as shown in FIG. 1B, has become problematic. FIG. 1B illustrates a diagram of VN bottleneck. This is particularly true for data-centric applications, such as real-time image recognition and natural language processing, where state-of-the-art VN systems work hard to match the performance of an average human.

The increased demand for machine learning on very large datasets and the growing offering of artificial intelligence services on the cloud has driven a resurgence in custom hardware designed to accelerate multiply and accumulate (MAC) computations, which are a fundamental mathematical operation used for example in matrix-vector multiplication (MVM) operations. The MAC computation produces a sum of multiplications. For example, the MAC computation can produce a sum of scalar products in accordance with a dot product of two vectors.

Modified computing architectures have been adopted to enhance computing capability and efficiency. For example, graphics processing units (GPUs) with multiple cores and high-throughput interconnections are among fairly successful attempts to increase the parallelism in computing. When GPUs are used for neural networks, the synaptic weights are stored in separated units, such as static random access memory (SRAM), that need to be visited frequently for data fetching and constantly powered up to store the information. The tensor processing unit, a type of application specific integrated circuit, demonstrates a further improved power efficiency by using low-precision computation at high volume, but the latency issue still remains.

Most, if not all, of the custom silicon computing hardware, i.e., field programmable gate arrays (FPGAs), application-specific integrated circuits (ASICs), and GPUs, depend on the same underlying electronic components, which are fundamentally limited in both speed and energy by Joule heating, radio frequency (RF) crosstalk, and capacitance. The last of these, capacitance, dominates energy consumption and limits the maximum operating speed in neural network hardware accelerators. This is because, the movement of data (e.g., trained network weights), rather than arithmetic operations, requires the charging and discharging of chip-level metal interconnects. Thus, improving the efficiency of logic gates at the device level provides diminishing returns in such applications, if the flow of data during computation is not simultaneously addressed.

The ability to perform computing at the site where data is stored (‘in-memory computing’) is resurging as an alternative to current computing schemes. FIG. 2 illustrates a scheme for in-memory computing. Under the in-memory computing scheme 200, the processing may be performed at the memory, as shown via line 202 for example. First proposed in the 1960s, the concept of in-memory computing was initially demonstrated in the digital domain. Various emerging electronic devices, taking advantage of physical phenomena such as spin, phase transition or ionic transport, are becoming more mature both in physical understanding and technological developments. New computing systems, based on the intriguing Non-Von Neumann (Non-VN) computing paradigm, using the in-memory computing concept have built upon these beyond-CMOS (complementary metal-oxide-semiconductor) devices and nanotechnology, offering an attractive solution to the energy consumption and speed issues. The scaling of dense non-volatile memory (NVM) crossbar arrays to few-nanometer critical dimensions has been recognized as one path to build computing systems that can mimic the massive parallelism and low-power operation found in the human brain.

Recent developments in the field include memristive crossbar arrays to compute in the analog domain, for example as described in C.-X. Xue et al., “16.1 A 22 nm 4 Mb 8b-Precision ReRAM Computing-in-Memory Macro with 11.91 to 195.7 TOPS/W for Tiny AI Edge Devices,” 2021 IEEE International Solid-State Circuits Conference (ISSCC), 2021, pp. 245-247. However, such devices do not have the potential for parallelizing the MVM operations. Challenges include the need for a robust computational scheme, the need for peripheral circuitry that can support massively parallel access to NVM arrays, the need for an integrated crossbar ‘selection device’, and the need to understand the impact of the inherent limitations of NVM devices (finite dynamic range, imperfect device reliability and variability, and the non-zero programming energy) on network performance.

Because the physical properties and switching behaviors of NVM devices vary considerably with device type, various computational schemes have been proposed for implementing both synapses and neurons in neuromorphic networks using NVM. Peripheral circuitry has been proposed for the realization of hybrid CMOS/NVM neuromorphic chips. Exploiting the density of nanoscale crossbar NVM arrays requires compact, efficient CMOS neurons and/or innovative techniques for matching the disparate length scales.

Given the context of computational hardware for obtaining architectures that efficiently mimic the biological circuitry of the brain, it is necessary to explore and revise the operational paradigms of current logic computing platforms when performing matrix algebra. One approach is by replacing sequential and temporized operations, and their associated continuous access to memory, with massively parallelized distributed analog dynamical units for delivering efficient post-CMOS devices and systems summarized as non-von Neumann architectures. In this paradigm shift, the wave nature of light and related inherent operations, such as interference and diffraction, can play a significant role in enhancing computational throughput and concurrently reducing the power consumption of neuromorphic platforms.

In recent years, the revolutionizing impact of neural networks (NNs) has contributed to the development of multiple emerging technologies, ranging from free space diffractive optics to nanophotonic processors aiming to improve the computational efficiency of specific tasks performed by NNs. Integrated photonic platforms can indeed provide parallel, power-efficient, and low-latency computing.

As may be appreciated by a person skilled in the art, analog wave chips can perform dot product inherently using light matter interactions such as via a phase shifter or modulator. Analog wave chips can further enable signal accumulation (summation) by either electromagnetic coherent interference or incoherent accumulation through detectors. Analog wave chips can further enable parallelism strategies and higher throughput using multiplexing schemes. However, such analog wave chips are still subject to improvement, for example in terms of latency, throughput and power usage.

Therefore, there is a need for a mixed-mode crossbar array for computation, and associated methods, that obviates or mitigates one or more limitations in the prior art, such as mentioned above.

This background information is intended to provide information that may be of possible relevance to the present invention. No admission is necessarily intended, nor should be construed, that any of the preceding information constitutes prior art against the present invention.

### SUMMARY OF THE INVENTION

Embodiments of the present disclosure generally provide for a method and apparatus for performing computations using mixed-mode memory elements having contents which are accessible via both optical and electrical interactions. In particular, an array of such elements are accessed through both optical and electrical “crossbar” array structures, which are integrated together. Applications to machine learning, e.g. neural network training, are also provided for.

According to an embodiment of the present disclosure, there is provided an apparatus comprising: an input waveguide configured to propagate an input optical signal; an output waveguide configured to provide an output optical signal; and a processing component. The processing component includes an input optical coupler, a mixed-mode memory element and an output optical coupler. The input optical coupler is operatively coupled to the input optical waveguide and configured to couple at least a portion of the input optical signal onto an optical processing pathway of the processing component. The mixed-mode memory element is located along the optical processing pathway and configurable to exhibit a persistent state which is programmable using a respective write control signal and which exhibits an electrical characteristic corresponding to the state and an optical property corresponding to the state. The mixed-mode memory element is configured to manipulate said portion of the input optical signal according to the optical property of the persistent state to produce an output. The output optical coupler is configured to receive the output of the mixed-mode memory element and couple said output onto the output waveguide in order to provide at least a portion of said output optical signal. The apparatus further includes an electrical readout circuit configured to electrically interact with the mixed-mode memory element to produce an electrical readout signal which varies with the electrical property of the mixed-mode memory element. Multiple input waveguides, output waveguides, and associated processing components can be provided in a crossbar array form. Accordingly, mixed-mode memory elements can be read out both optically and electrically.

In various examples of some preceding embodiments, the write control is an electrical write control signal. In various examples of some preceding embodiments, the mixed-mode memory element is an electro-optical plasmonics device. The mixed-mode memory element may include a phase change material that causes the persistent state based on the electrical write control signal. The persistent state may then correspond to a degree to which the phase change material is crystalline or amorphous. The electrical property may be a resistance or a conductance, thus facilitating electrical readout. In some preceding embodiments, the electrical interacting includes applying a voltage at a first terminal and measuring a resultant voltage or current. In some preceding embodiments, the optical property of the mixed-mode memory element comprises a controllable optical transmittance by which an intensity of light making up the portion of the input optical signal is controllably adjusted. In some preceding embodiments, the apparatus is configured to perform a multiplication between a first value represented using a power or amplitude of the input optical signal and a second value represented using the controllable optical transmittance, the multiplication comprising setting the power or amplitude of the input optical signal and adjusting said portion of the input optical signal according to the controllable optical transmittance. Thus, multi-element (e.g. vector or matrix) multiplications can be performed optically.

In some preceding embodiments, the apparatus includes a readout device having a photodetector operatively coupled to the output waveguide and configured to generate an output signal indicative of the output optical signal. The apparatus may further include a controller configured to: cause an optical signal source to provide the input optical signal to the input waveguide, the input optical signal having an intensity which is set in response to a signal from the controller; obtain the output signal from the readout device or cause other electronics to obtain the output signal from the readout device; and operate the electrical readout circuit and obtain the electrical readout signal or cause the other electronics or further electronics to obtain the electrical readout signal. In some preceding embodiments, the controller is further configured to cause the mixed-mode memory element to be programmed based on the output signal and the electrical readout signal. In some preceding embodiments, the programming is performed as part of a neural network training operation. Thus, electrical readout of mixed-mode memory elements is provided, and the apparatus can interact with the mixed-mode memory elements optically in one way, e.g. to perform a first multiplication, subsequently electrically, e.g. to perform a further multiplication based on results of the first multiplication, and then subsequently the mixed-mode memory elements can be reprogrammed. This interaction can be used to train a neural network in accordance with forward and backward propagation steps.

In some preceding embodiments, the apparatus further includes one or more additional output waveguides and one or more additional processing components. Each additional output waveguide is configured to provide a further respective output optical signal. Each additional processing component includes a further respective input optical coupler; a further respective mixed-mode memory element; and a further respective output optical coupler. The further respective input optical coupler is operatively coupled to the input waveguide and configured to couple a further respective portion of the input optical signal onto a further respective processing pathway of the additional processing component. The further respective mixed-mode memory element is located along the further respective processing pathway and configurable to exhibit a further respective persistent state which is programmable using a further respective write control signal and which exhibits a further electrical characteristic corresponding to the further respective persistent state and a further respective optical property corresponding to the further respective persistent state. The further respective mixed-mode memory element is configured to manipulate said further respective portion of the input optical signal according to the optical property of the further respective persistent state to produce a further respective output. The further respective output optical coupler is configured to receive the further respective output of the further respective mixed-mode memory element and couple said output onto a different corresponding one of the additional output waveguides in order to provide at least a portion of the further respective output optical signal thereof. Further, the electrical readout circuit is configured to electrically interact with multiple mixed-mode memory elements, including the mixed-mode memory element and each further respective mixed-mode memory element of the one or more additional processing components, to produce the electrical readout signal. In some preceding embodiments, the electrical readout signal varies with combined electrical properties of the multiple mixed-mode memory elements. In some preceding embodiments, the electrical readout signal is indicative of a multiply and accumulate operation in which different voltages are applied to different respective inputs of different ones of the mixed-mode memory elements, wherein said electrical characteristic and each said further electrical characteristic is an electrical resistance or conductance, the multiply and accumulate operation performed by reading electrical outputs of the mixed-mode memory outputs which vary in accordance with said voltages and said electrical resistance or conductance. In some preceding embodiments, the apparatus further includes a readout device comprising one or more balanced photodetectors, each of the balanced photodetectors operatively coupled to at least one respective pair of output waveguides including the output waveguide and the additional output waveguides, each of the balanced photodetectors configured to generate an output signal indicative of a difference between pairs of output optical signals provided thereto via said respective pair of output waveguides. Thus, embodiments with multiple output waveguides, for multiplying a quantity represented by an input optical signal with multiple values, is explicitly provided for. The balanced photodetectors can be used to implement signed values in the multiplication.

In some preceding embodiments, the apparatus further includes one or more additional input waveguides and one or more additional processing components. Each additional input waveguides is configured to propagate a further respective input optical signal. Each additional processing component includes a further respective input optical coupler; a further respective mixed-mode memory element; and a further respective output optical coupler. The further respective input optical coupler is operatively coupled to a different corresponding one of the additional input waveguides and configured to couple at least a portion of the further respective input optical signal thereof onto a further respective processing pathway of the additional processing component; The further respective mixed-mode memory element is located along the further respective processing pathway and configurable to exhibit a further respective persistent state which is programmable using a further respective write control signal and which exhibits a further electrical characteristic corresponding to the further respective persistent state and a further respective optical property corresponding to the further respective persistent state. The further respective mixed-mode memory element is configured to manipulate said further respective portion of the input optical signal according to the optical property of the further respective persistent state to produce a further respective output. The further respective output optical coupler is configured to receive the further respective output of the further respective mixed-mode memory element and couple said output onto the output waveguide in order to provide a further respective portion of the output optical signal thereof. The electrical readout circuit is configured to electrically interact with multiple mixed-mode memory elements comprising the mixed-mode memory element and each further respective mixed-mode memory elements of the one or more additional processing components to produce a plurality of electrical readout signals including the electrical readout signal. Thus, embodiments with multiple input waveguides, for multiplying multiple quantity represented by multiple input optical signals with at least one value, is explicitly provided for.

In some preceding embodiments, the electrical readout circuit comprises multiple sub-circuits, each sub-circuit being configured to electrically interact with a respective set of one or more mixed-mode memory elements, from the mixed-mode memory element and the further respective mixed-mode memory elements, said respective set consisting of mixed-mode memory elements operatively coupled to a same input waveguide, each sub-circuit thereby producing a corresponding electrical readout signal of the plurality of electrical readout signals, the corresponding electrical readout signal varying with combined electrical properties of said one or more mixed-mode memory elements. In some preceding embodiments, each sub-circuit is configured is configured to implement a vector multiplication between a first respective vector represented by voltages applied to the set of one or more mixed-mode memory elements and a second respective vector represented by states of the set of one or more mixed-mode memory elements. In some preceding embodiments, the multiple sub-circuits operate concurrently to produce the plurality of electrical readout signals, and wherein for each sub-circuit the first respective vector is a same vector. In some preceding embodiments, different output optical couplers, of the output optical coupler and the further respective output optical couplers, are configured to couple different, non-overlapping bands of wavelengths onto the output waveguide, the output optical signal generated based on cumulative outputs of the processing components, the apparatus further comprising a readout device comprising a photodetector configured to generate an output signal based on total intensity of the output optical signal.

In some preceding embodiments, the apparatus further includes a second output waveguide configured to provide a second output optical signal and a second processing component. The second processing component includes a second input optical coupler, a second mixed-mode memory element, and a second output optical coupler. The second input optical coupler is operatively coupled to the input waveguide and configured to couple a second portion of the input optical signal onto a second processing pathway of the second processing component. The second mixed-mode memory element is located along the second optical processing pathway and configurable to exhibit a second persistent state which is programmable using a second respective input electrical signal and which exhibits a second electrical characteristic corresponding to the second persistent state and a second optical property corresponding to the second persistent state. The second mixed-mode memory element is configured to manipulate said second portion of the input optical signal according to the second optical property of the second respective persistent state to produce a second output. The second output coupler is configured to receive the second output of the second mixed-mode memory element and couple said output onto the second output waveguide in order to provide at least a portion of the second output optical signal thereof. Further, the mixed-mode memory element is configured to modify an intensity of said portion of the input optical signal by a first factor, and the second mixed-mode memory element is a configured to modify an intensity of said second portion of the input optical signal by a second factor. Further, the electrical readout circuit is configured to electrically interact with the mixed-mode memory element and the second mixed-mode memory element to produce the electrical readout signal which varies with combined electrical properties of the mixed-mode memory elements and the second mixed-mode memory element. Further, the apparatus is configured to photonically multiply a first value by a second value, the first value represented by an intensity of the input optical signal, the second value being a signed value represented by a difference between the first factor and the second factor. A technical effect of the above is that signed values in a multiplication can be represented by pairs of photonic processing components.

In some preceding embodiments, the electrically interacting comprises: electrically interacting with the mixed-mode memory element to produce a first electrical readout signal which varies with the electrical property of the mixed-mode memory element; electrically interacting with the second-mixed mode memory element to produce a second electrical readout signal which varies with the second optical property of the second mixed-mode memory element; and generating a difference between the first electrical readout signal and the second electrical readout signal. In some preceding embodiments the apparatus further includes a balanced photodetector configured to receive the output optical signal and the second output optical signal, and to produce an output signal indicative of the difference between the first output optical signal and the second output optical signal.

According to another embodiment of the present disclosure, there is provided an apparatus comprising a plurality of input waveguides each configured to propagate a respective input optical signal; a plurality of output waveguides each configured to provide a respective output optical signal; and a plurality of processing components. Each processing component includes a respective input optical coupler, a respective mixed-mode memory element, and a respective output optical coupler. The input optical coupler is operatively coupled to one of the input waveguides and configured to couple a respective portion of the input optical signal thereof onto a respective optical processing pathway of the processing component. The mixed-mode memory element is located along the respective optical processing pathway and configurable to exhibit a persistent state which is programmable using a respective write control signal and which exhibits an electrical characteristic corresponding to the state and an optical property corresponding to the state. The mixed-mode memory element is configured to manipulate said respective portion of the input optical signal according to the optical property of the persistent state to produce an output. The output optical coupler is configured to receive the output of the respective mixed-mode memory element and couple said output onto one of the output waveguides in order to provide a portion of the output optical signal thereof. One or both of the following conditions hold: each one of the input waveguides is optically coupled to a first corresponding set of two or more of the processing components; and each one of the output waveguides is optically coupled to a second corresponding set of two or more of the processing components. The apparatus further includes an electrical readout circuit configured to electrically interact with the mixed-mode memory elements to produce one or more electrical readout signals which vary with the electrical properties of the mixed-mode memory elements.

In some embodiments, the apparatus further includes a readout device comprising one or more photodetectors operatively coupled to the plurality of output waveguides, the photodetectors configured to generate a plurality of output signals each indicative of one or a combination of the respective output optical signals. The apparatus further includes a controller configured to: cause one or more optical signal sources to provide the respective input optical signals to the plurality of input waveguides, the input optical signals each having an intensity which is set in response to a signal from the controller; obtain the output signals from the readout device or cause other electronics to obtain the output signals from the readout device; and operate the electrical readout circuit and obtain the one or more electrical readout signals or cause the other electronics or further electronics to obtain the one or more electrical readout signals.

In some preceding embodiments, each photodetector of the one or more photodetectors is: operatively coupled to a different respective output waveguide of the plurality of output waveguides; and configured to generate an output signal of the plurality of output signals, said output signal indicative of the respective output optical signal of said corresponding output waveguide. In some preceding embodiments, the electrical readout circuit comprises multiple sub-circuits, each corresponding to a different input waveguide, each sub-circuit being configured to electrically interact with a respective set of said mixed-mode memory elements, said respective set consisting of mixed-mode memory elements operatively coupled to a same one of the input waveguides, each sub-circuit thereby producing a corresponding electrical readout signal of the one or more electrical readout signals, the corresponding electrical readout signal varying with combined electrical properties of said set of mixed-mode memory elements. In some preceding embodiments, the apparatus is configured to optically perform a multiplication between a multiplicand and a multiplier, the output signals being indicative of a result of the multiplication. In such embodiments, the controller is further configured to: determine a set of errors based on a difference between the output signals and an expected outcome of the multiplication; and operate the electrical readout circuit to perform a second multiplication between the set of errors and values represented by said states of the mixed-mode memory elements. In some preceding embodiments, the apparatus is further configured to reprogram the mixed-mode memory elements based on a result of the second multiplication. In some embodiments, the apparatus is further configured to iteratively repeat the multiplication, the second multiplication and the reprogramming a plurality of times to perform a neural network training operation. In some preceding embodiments, the apparatus further includes a readout device comprising one or more balanced photodetectors, each of the balanced photodetectors operatively coupled to at least one pair of the output waveguides, each of the balanced photodetectors configured to generate an output signal indicative of a difference between pairs of output optical signals provided thereto. In some embodiments, different ones of the output optical couplers are configured to couple different, non-overlapping bands of wavelengths onto said ones of the output waveguides associated therewith, said different ones of the output optical couplers being parts of different respective ones of the processing components which are operatively coupled to different ones of the input waveguides. In some embodiments, further different ones of the output optical couplers are configured to couple a same band of wavelengths onto said ones of the output waveguides associated therewith, said further different ones of the output optical couplers being parts of further different respective ones of the photonic processing components which are operatively coupled to a same one of the input waveguides.

According to another embodiment of the present disclosure, there is provided a method including programming a set of mixed-mode memory elements of a crossbar array to represent values of a multi-component multiplier. Each mixed-mode memory element is configurable to exhibit a persistent state which is programmable using a respective write control signal and which exhibits an electrical property corresponding to the state and an optical property corresponding to the state. The method includes providing a set of input optical signals to a set of input optical waveguides of the crossbar array. Each input waveguide is configured to propagate a respective input optical signal. The set of input optical signals is indicative of a multi-component multiplicand to be multiplied by the multiplier. The crossbar array is configured to cause the set of input optical signals to interact with the set of mixed-mode memory elements to generate output optical signals which are indicative of a result of multiplying the multiplier with the multiplicand. The method includes monitoring a readout device configured to provide a set of electrical output signals indicative of the set of optical output signals as provided by a set of output waveguides of the crossbar array. The method includes operating an electrical readout circuit to electrically interact with the set of mixed-mode memory elements to produce one or more electrical readout signals which vary with the electrical properties of the mixed-mode memory elements.

In some preceding embodiments, the method further includes determining a set of errors based on a difference between the monitored electrical output signals and an expected outcome of the result of multiplying the multiplier with the multiplicand. The determining the set of errors may include: comparing each one of the set of electrical output signals with a corresponding component of the expected outcome; and generating the set of errors based on the comparing, wherein the set of errors comprises a separate error for each one of the set of electrical output signals.

In some preceding embodiments, the method further included providing the set of errors to a control circuit operatively electrically coupled to the mixed-mode memory elements; and causing the electrical readout circuit to apply a set of readout electrical signals based on the generated set of errors. The set of readout electrical signals each represents one of the set of errors. The electrical readout circuit is configured to produce an output indicative of a multi-component multiplication between the set of errors and a set of values programmed into the mixed-mode memory elements and expressed via the electrical properties thereof. The method may further include reprogramming the mixed-mode memory elements based on the output indicative of the multi-component multiplication. The method may further include iteratively repeating the method a plurality of times to perform a neural network training operation.

In various embodiments there is provided a computer program product comprising a computer readable medium. The computer readable medium stores thereon computer program instructions which, when executed, cause the computer to perform a method as described above or elsewhere herein. The computer may be a general purpose computer or a specialized computing device.

Embodiments of the present disclosure can provide for or facilitate an application-specific optical processor which is less limited by energy-bandwidth trade-off of electrical interconnects. Accordingly, advantages from fields such as optical networking can be applied to the field of computing. Embodiments may potentially provide or lead to high computational throughput via low-latency (i.e., information processing and propagation at the speed of light) and parallel operations in a single physical optical processing core using wavelength division multiplexing (WDM). The use of WDM may essentially provide for an additional scaling dimension through use of frequency space. Another potential advantage of embodiments of the present disclosure is low static power consumption, for example by use of photonic memory units. Another potential advantage is that neural network training involving optical forward propagation and electrical backpropagation on a physical chip device is enabled. Another potential advantage is that a smaller footprint can be realized, when compared to an all-optical tensor core.

Embodiments have been described above in conjunctions with aspects of the present disclosure upon which they can be implemented. Those skilled in the art will appreciate that embodiments may be implemented in conjunction with the aspect with which they are described, but may also be implemented with other embodiments of that aspect. When embodiments are mutually exclusive, or are otherwise incompatible with each other, it will be apparent to those skilled in the art. Some embodiments may be described in relation to one aspect, but may also be applicable to other aspects, as will be apparent to those of skill in the art.

### BRIEF DESCRIPTION OF THE DRAWINGS

FIG. 1A is a schematic diagram illustrating a computing system.

FIG. 1B is a schematic diagram illustrating a bottleneck in a computing system.

FIG. 2 is a schematic diagram illustrating an in-memory computing system.

FIG. 3 is a schematic diagram illustrating a mixed-mode memory element, in accordance with embodiments of the present disclosure.

FIG. 4 is a schematic diagram illustrating a cross-sectional view of a CMOS-integrated mixed-mode crossbar array device, in accordance with embodiments of the present disclosure.

FIG. 5A is a schematic diagram illustrating a mixed-mode memory element responsive to an electrical switching input signal, in accordance with embodiments of the present disclosure.

FIG. 5B is a block diagram illustrating a model which can be used to represent the mixed-mode memory element, in accordance with embodiments of the present disclosure.

FIG. 6 is a schematic diagram illustrating a mixed-mode crossbar array apparatus, in accordance with embodiments of the present disclosure.

FIG. 7 illustrates a matrix-vector multiplication (MVM) as may be implemented by a photonic operation of embodiments of the present disclosure.

FIG. 8A is a schematic diagram illustrating a mixed-mode crossbar array apparatus, in accordance with embodiments of the present disclosure, with balanced photodetectors at readout.

FIG. 8B is a schematic diagram illustrating a mixed-mode crossbar array apparatus, in accordance with embodiments of the present disclosure, with single photodetectors (e.g. photodiodes) for optical to electrical (O/E) conversions at readout.

FIG. 9 is a schematic diagram illustrating an electrical readout circuit for use with a mixed-mode crossbar array apparatus, in accordance with embodiments of the present disclosure.

FIG. 10 is a schematic diagram representing implementation of a synaptic layer of a convolutional neural network using a mixed-mode crossbar array apparatus, in accordance with embodiments of the present disclosure.

FIG. 11 is a schematic diagram illustrating implementation of an embodiment of the present disclosure in performing forward and back propagation for supporting machine learning.

FIG. 12 is a schematic diagram illustrating an embodiment of the present disclosure, including a mixed-mode crossbar array integrated with an analog processing unit, embedded memory, and electronic read, write and control circuitry.

FIG. 13 is a schematic diagram illustrating operation of a crossbar apparatus, in accordance with an embodiment of the present disclosure, including forward and backward propagation neural network training operational details.

FIG. 14 is a schematic diagram illustrating an apparatus, in accordance with embodiments of the present disclosure, with APU, control units and programming blocks.

FIG. 15 is a flowchart diagram illustrating steps in a programming operation to update the weights held in the mixed-mode memory elements in a neural network training implementation, in accordance with embodiments of the present disclosure.

FIG. 16 is a schematic diagram showing how values (e.g. weights) can be encoded into an N-bit binary or low-precision format and then stored in N lower-precision mixed-mode memory elements instead of one higher-precision mixed-mode memory element, in accordance with embodiments of the present disclosure.

FIG. 17 is a schematic diagram of an electronic device, in accordance with embodiments of the present disclosure.

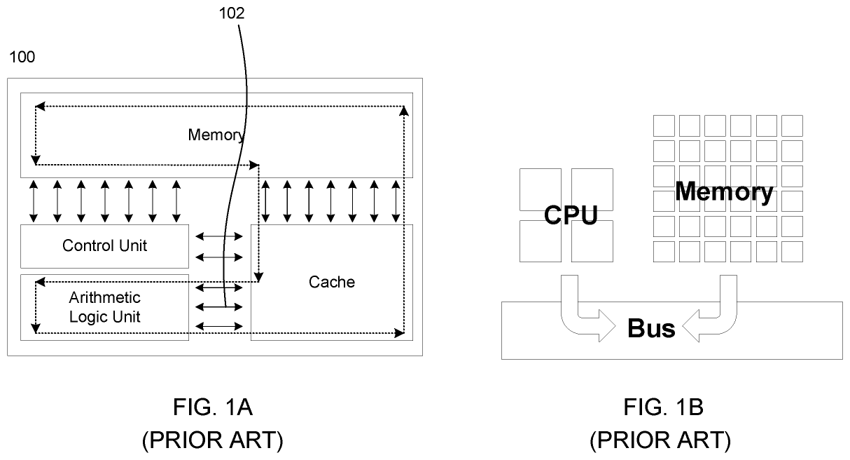

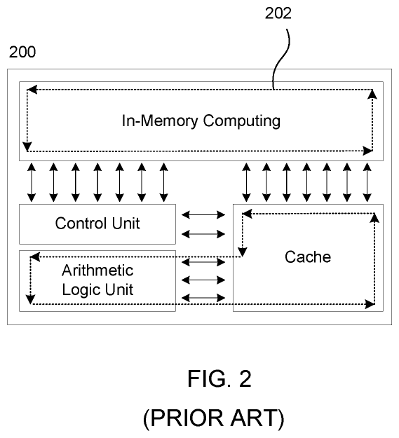

It will be noted that throughout the appended drawings, like features are identified by like reference numerals.

### DETAILED DESCRIPTION OF THE INVENTION

Embodiments of the present disclosure contribute to the use of optical technologies, for example in providing more scalable and efficient neuromorphic systems. Silicon photonic circuits implementing either reservoir computing (RC) or photonic spiking techniques are, for example, able to execute high-speed computational tasks at low power. Out of the requirement for low losses, the inherently large footprint of purely optical systems, however, precludes the large integration density needed for the implementation of competitive neural networks. Integration of optical components together with CMOS compatible manufacturing can provide for the combination, on chip, of both energy-efficient optical memory units and a compact, broadband multi-channel laser source, within a scalable photonic architecture.

Recent work on integrated photonic processors for MVMs and neuromorphic computing may provide potential advantages, but key issues such as large footprints due to using Silicon Nitride (SiN) as waveguides and thermo-optic heaters may present bottlenecks. Thermo-optic heaters may be used to tune the phase or resonance wavelength of related components (ranging on average from 1 mW to 10 mW per heater for ring resonators and Mach-Zehnder interferometers respectively). Further, resonant devices such as add-drop resonators may limit the modulation bandwidth.

A desirable artificial intelligence (AI) or machine learning platform may combine the high density processing capabilities offered by the electronic domain with the high bandwidth and low energy consumption provided by the optical domain.

Embodiments described herein may provide for a mixed-mode device operating in both the electrical and optical domains (referred to in combination as the electro-optical or mixed-mode domain). Such a device can be leveraged to take advantages from each of the electrical and optical domains while limiting the drawbacks of same. In this regard, optically actuated memristors with inherent memory functionalities may be employed as stateful modulators and photodetectors. By processing both electrical and optical signals, AI circuits may be enhanced, either by enhancing current applications or by paving the way for other ones.

To fully exploit the advantages of dense electronics and high-speed optics, embodiments may provide for crossbar array based on memristive synapses and neurons operating in the electro-optical domain. Combining high-density electro-optical memristors with high-bandwidth photonic circuits may provide for an enhanced design for an electro-optical or mixed-mode crossbar array platform which can provide desirably high throughput, energy efficiency and compute-density in comparison with all-optical or all-electronic crossbar array architectures.

An approach to implement synaptic or neuronal behaviors may comprise regulating the state of the memristor with electrical or optical programing signals. Optical and electrical properties of the memristor adjust based on the state, thus allowing information stored the memristor to be read via either the optical or the electrical domain. Embodiments in which the programing and readout signals reside in potentially different domains may be useful for direct conversion of information between domains. For instance, a memristor can be electrically programmed and optically read.

Embodiments described herein employ features of electro optical neuromorphic hardware based on memristors as a solution for low-power (e.g. fJ/bit) and high-speed (e.g. GHz bandwidth) computation and communication, while exploiting the concept of electro-optical synapses and neurons enabled by memristive and photonic technologies.

Although integrated photonics has gained significant traction over the last decade, primarily for its potential to overcome fundamental limitations of today's electronic circuitry, the conversion of electrical and optical signals seamlessly on a chip has remained elusive. The development of compact devices for efficient electro-optic conversion holds great importance as sharing the computing load between the electrical and optical domains shows increasing potential for applications including integrated optical switches, reconfigurable photonic circuits, photonic artificial neural networks, and more.

Phase-change materials (PCMs) are potential candidates for mixed-mode devices as they, in principle, provide both electrical and optical modulation functionality. To this effect, several devices implementing nonvolatile, optical PCMs have been proposed, but only a few have been successfully demonstrated on an integrated platform. This is because the high electrical contrast between the conductive and insulating state in PCMs requires very close spacing between the metal contacts (usually tens of nanometers) to initiate a phase transition. In addition, the resulting conductive region formed after electrical switching is, at most, a few hundred nanometers in diameter, thus reducing the total volume of material for light-matter interaction. Many such devices may also exhibit high power consumption and large physical footprints arising from their volatility and inherent operational instability.

The development and integration of improved phase change and nonlinear chalcogenide semiconductors (alloys of sulphur, selenium and tellurium), such as waveguide-integrated electro-optic PCM memory cell, GeSbTe (GST), may lead to better performance across a range of performance metrics. Such PCM memory cells may be fully addressable in both electrical and optical domains. Such PCM memory cells may be manufactured using a variety of atomic and device level techniques including high-throughput physical vapor deposition for combinatorial material optimization in conjunction with interlayer and metamaterial nanostructuring. Further developments may lead to the integration of the developed materials and designs into a range of future photonic computing architectures with particular focus on addressable crossbar arrays.

Previous demonstrations of such mixed-mode devices either have used nonvolatile PCMs, such as VO₂-based devices which require significant power consumption for data retention, or have been limited to write and erase operations either electrically or optically but not both. Combining plasmonics with PCMs may satisfy stringent requirements, because the dimensions of such devices can be reduced to tens of nanometers and smaller, significantly below the diffraction limit of traditional optical devices. By exploiting both the nanoscale dimensions and strong field confinement of a plasmonic nanogap, embodiments of the present disclosure may facilitate both electrical and optical nonvolatile switching of GST within the gap, allowing for full mixed-mode operation of a PCM memory cell leading to low-loss light delivery and strong light-matter interaction in a compact footprint. In addition, the extremely high field enhancement possible with subwavelength nanogaps may enable high-sensitivity spectral measurement.

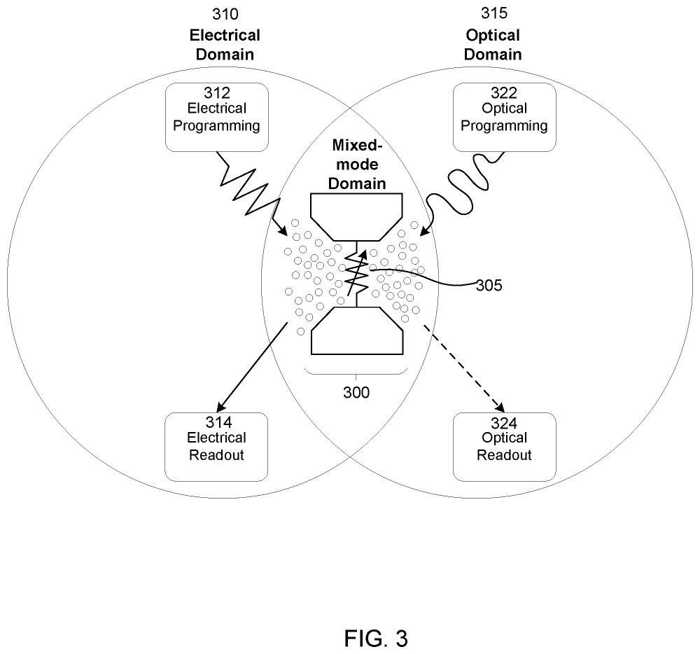

FIG. 3 illustrates a mixed-mode memory element 300 according to an embodiment of the present disclosure. This mixed-mode memory element can facilitate an implementation of neuromorphic computing in the electrical 310 and optical 320 domains. As illustrated, the mixed-mode memory element 300 may be programmed (i.e., to change state) electrically 312 or optically 322. In an embodiment, the mixed-mode memory element may be electrically programmed only. This may be because optical programming is possible but not used. Furthermore, optical programming typically requires separate laser sources which increases the overall power consumption and footprint for a crossbar array. Alternatively, a type of memory element which is only capable of being programmed in one domain (e.g. electrical domain) may be used. The state of the mixed-mode memory element 300 may be read out both electrically 314 and optically 324. The mixed-mode memory element 300 is illustrated as having a programmably variable resistance 305 and variable optical properties, for example by adjustment of a PCM in a plasmonics implementation.

The approach of FIG. 3 may take advantage of some characteristics (e.g. high density) of the electrical domain and other characteristics (e.g. high bandwidth) of the optical domain can be realized by combining them at the interface.

Accordingly, embodiments of the present disclosure utilize a mixed-mode memory element which is configurable to exhibit a persistent state. That is, the mixed-mode memory element is configurable into any one of a plurality of persistent states in response to a write control signal. The mixed-mode memory element can incorporate a PCM, for example, and the state can be a degree to which the PCM which is in a crystalline state as opposed to an amorphous state (e.g. a proportion of the PCM which is crystalline). The state may be persistent in the sense that the state remains substantially the same after the write control signal (and possibly all power in the case of a non-volatile element) is removed. The mixed-mode memory element can be programmable, i.e. induced to change states, by application of the write control signal. In some embodiments, the write control signal can be an electrical write control signal, for example in the form of a pulse having a controllable width, controllable amplitude, or combination thereof. The mixed-mode memory element (e.g. incorporating PCM) can change to a state which corresponds to the width, amplitude, or both, of the pulse. That is, the PCM can change its (persistent) state based on the characteristics (e.g. pulse width, amplitude) of the electrical write control signal. In some embodiments, as an alternative to a pulse having a controllable width, a controllable number of pulses each having a given width can be applied in succession. The state change can depend on the pulse energy (e.g. product of width and amplitude) applied in one or a series of pulses.

In various embodiments, the state of the PCM can be incremented or decremented by a given amount, by applying an electrical write control signal which adjusts the PCM state, from its current state, by such an amount. The electrical write control signal can depend on the current state of the PCM and the desired new state.

The electrical write control signal can modulate the optical transmittance state of the PCM. Multiple nonvolatile levels of transmission may be reached, for example as a result of the mixture between amorphous and crystalline PCM, by controlling the power of the electrical write control signal. Using electrical switching pulses with varying pulse energy, it is possible to move between more than two states with high repeatability. This multi-level operation of a PCM device relies on the freely accessible intermediate crystallographic states of the PCM, i.e. states with a mixture of crystalline and amorphous regions. These mixed states exhibit optical transmission properties lying between those of a fully crystalline state and those of a fully amorphous state. The PCM amorphous phase tends to have high electrical resistivity, while the crystalline phase exhibits a low resistivity. This significant resistance contrast is used to store information in the PCM (the high-resistance state can represent a logical ‘0’ while the low resistance state can represent a logical ‘1’, for example). One can set the width, amplitude, or both of the electrical pulse, to program multiple resistance (conductance) levels. In some embodiments, an electrical signal generator is configured to provide an electrical pulse with variable amplitude, variable pulse width, variable pulse number, or a combination thereof. The electrical signal generator is configured to provide current pulses for switching the modulating PCM element (i.e. mixed-mode memory element) of the waveguide coupling element, which gives rise to Joule heating in the doped waveguide thereby affecting the state of the modulating PCM element.

In some embodiments, the mixed-mode memory element has two different states, either of which is selectable as the current persistent state by application of an appropriate write control signal. For example, the PCM can be either in a fully crystalline or fully amorphous state. In other embodiments, the mixed-mode memory element has three, four or more different states, each of which is selectable as the current persistent state. For example, the PCM can be in a fully crystalline state, a fully amorphous state, or one of possibly multiple intermediate states in which the PCM is partially crystalline and partially amorphous. Each intermediate state can correspond to a different respective proportion of the PCM which is partially crystalline (or amorphous). As such, the persistent state can correspond to a degree to which the PCM is crystalline or amorphous. More generally, the state of the mixed-mode memory element is a physical state, with crystalline and amorphous states being examples of physical states.

The mixed-mode memory element is configured so that it exhibits an electrical property, such as a resistance or conductance, which corresponds to (and is typically due to) its current state. Furthermore, the mixed-mode memory element is configured so that it exhibits an optical property, such as an amount by which an incident optical signal is attenuated or absorbed, which corresponds to its current state. The electrical and optical properties can be observable properties which directly depend on, and are due to, the state. For example, a PCM in a crystalline state can inherently have different electrical and optical properties than the PCM in an amorphous state, and the PCM in intermediate states can have intermediate electrical and optical properties. By observing either the electrical property or the optical property, the state of the mixed-mode memory element can be determined. By putting the mixed-mode memory element in a certain state, information can be stored therein. The information is readable by observing the electrical property or the optical property. Light absorption may cause optical signal attenuation. For example, in the crystalline state, the PCM may be more absorptive, thus pulling the light towards the modulating element, resulting in stronger attenuation of the optical signal passing through. In the amorphous state, the absorption is reduced and therefore the modulating element does not attenuate the optical signal to the same degree.

The phase change material can thus be switched from a crystalline (ordered) phase to an amorphous (disordered) phase and vice-versa. This transformation is accompanied by a strong change of electrical and optical properties. The amorphous phase has a high resistivity and low optical reflectivity, whereas the crystalline phase has a low resistivity and a high optical reflectivity.

In some embodiments, the electrical property (and thus the state) is observed by performing an electrical interaction, using an electrical readout circuit. For example, a voltage difference can be applied across two electrical terminals of the mixed-mode memory element to cause current to flow through the memory element, where it is affected by the physical state thereof. Where the memory element includes a PCM, the current can flow through the PCM, which has a different electrical resistance (or its reciprocal, conductance) depending on its physical state (e.g. crystalline, amorphous, or an intermediate thereof). For a given voltage and electrical resistance, a certain amount of current flows. Knowing the voltage and measuring the current, the electrical resistance (which depends on the state) can be determined. The current can be measured directly or as a resultant voltage, for example induced across a measurement resistor due to the current flow.

Moreover, by applying a certain voltage difference across the two electrical terminals of the mixed-mode memory element, a multiplication operation can be performed. In particular, the voltage can be set to a first voltage level which represents a first value to be multiplied, while the conductance can be set (by programming the mixed-mode memory element) to a second value to be multiplied. Then, by Ohm's law, the amount of current that flows across the electrical terminals is equal to the voltage multiplied by the conductance, and thus the amount of current represents the first value multiplied by the second value.

Yet further, a MAC operation can be performed in the electrical domain as follows. Each of a plurality of mixed-mode memory elements can be programmed to exhibit its own respective conductance. Then, a different respective voltage can be applied across the two terminals of each of these mixed-mode memory elements. As discussed above, the resulting currents represent a product of a multiplication. The resulting currents can then be added together in an electrical circuit (e.g. digital or analog circuit) and the sum of all resulting currents can be measured. Because each of the currents represents a multiplication, the sum of currents represents the output of the MAC operation. The currents or the sum of currents can be regarded as an electrical readout signal. The sum of currents (electrical readout signal) varies with combined electrical properties of the plurality of mixed-mode memory elements (and also with the applied voltages).

The electrical readout circuit generally operates to electrically interact with the mixed-mode memory elements to produce one or more electrical readout signals. Each electrical readout signal varies with the (programmable) electrical properties of one or more mixed-mode memory elements, as described above. The electrical interaction can include, for example, applying a voltage across electrical terminals of mixed-mode memory elements and measuring a resultant voltage or current. Such a resultant voltage or current can be (or be part of) the produced electrical readout signal. As will be readily understood, a resultant voltage or current is exhibited in an electrical circuit in response to an applied voltage, in accordance with a resistance, conductance, or other impedance-like characteristic of a relevant part of the electrical circuit (in this case, the mixed-mode memory element). These resultant voltages or currents, or other electrical readout signals, can be obtained e.g. by inputting these signals into a further circuit, in analog or digital form.

In some embodiments, the mixed-mode memory element is an electro-optical plasmonics device. For example, the mixed-mode memory element can incorporate a PCM as described above, in combination with a plasmonic nanogap. Plasmonics is a particularly promising approach for satisfying stringent requirements of computing platforms, because the dimensions of such devices can be reduced to tens of nanometers and smaller, potentially leading to a much smaller photonic crossbar array with desirably good performance. A plasmonics-based mixed-mode crossbar array with nanoscale lateral footprints can potentially lead to a very compact design with down to femto-joule/bit switching power consumption.

In more detail, by exploiting both the nanoscale dimensions and strong field confinement of a plasmonic nanogap, both electrical and optical nonvolatile switching of GbSbTe (GST) within the gap can be enabled. This can allow for full mixed-mode operation of a PCM memory cell leading to low-loss light delivery and strong light-matter interaction in a compact footprint. In addition, the high field enhancement possible with subwavelength nanogaps facilitates very high-sensitivity spectral measurement. While electronic computing systems already explore atomic scales devices in the form of memristors, photonic computing architectures mainly deal with modulation devices at larger scales. Photonic plasmonic and ionic switches that operate on the atomic scale may allow for fast and reproducible switching by means of the relocation of an individual or, at most, a few atoms in a plasmonic cavity. Depending on the location of the atom, many distinct plasmonic cavity resonance states can be configured. These switches can be integrated with waveguide architectures into a similar crossbar array architecture, as described elsewhere herein, for signal modulation with low power consumption in a quasi-analogue manner.

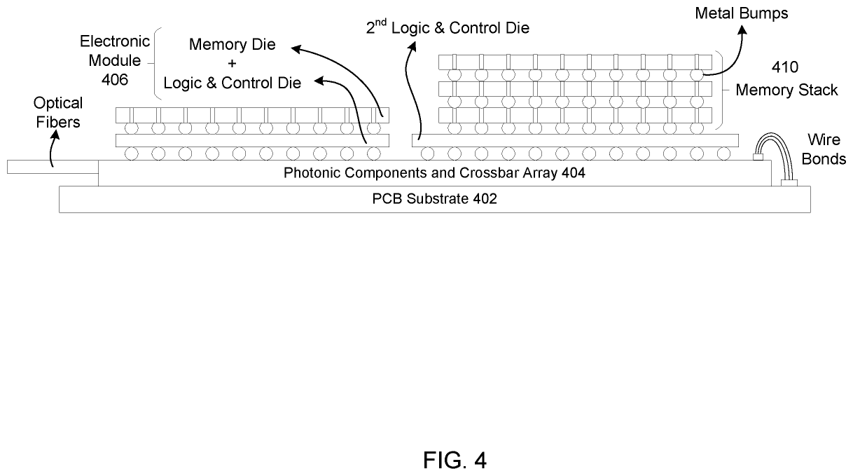

FIG. 4 illustrates a cross-sectional view of a CMOS-integrated mixed-mode crossbar array device, according to an embodiment of the present disclosure. The integrated system comprises a Resistive Random-Access Memory (RRAM) based 3D memory stack 410 for analog storage which can also be utilized as a separate in-memory computing platform. The RRAM stack can also be replaced with High Bandwidth Memory (HBM) in some embodiments. The device can include a photonic components 404 located on a substrate 402. The substrate 402 may be a PCB substrate or another substrate such as an organic or ceramic interposer, or the like. The photonic components can be integrated into a silicon photonics chip and can include the crossbar array structure, including waveguides and optical couplers. These photonic components can be coupled to other components via optical fibers and wire bonds. Electronic modules, such as logic and control circuitry can be coupled to the top of the photonic component device.

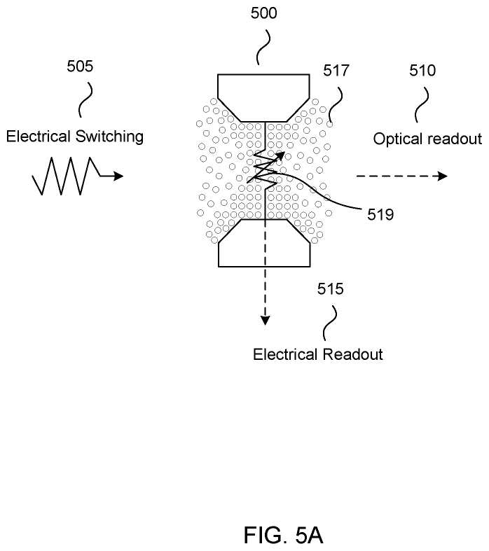

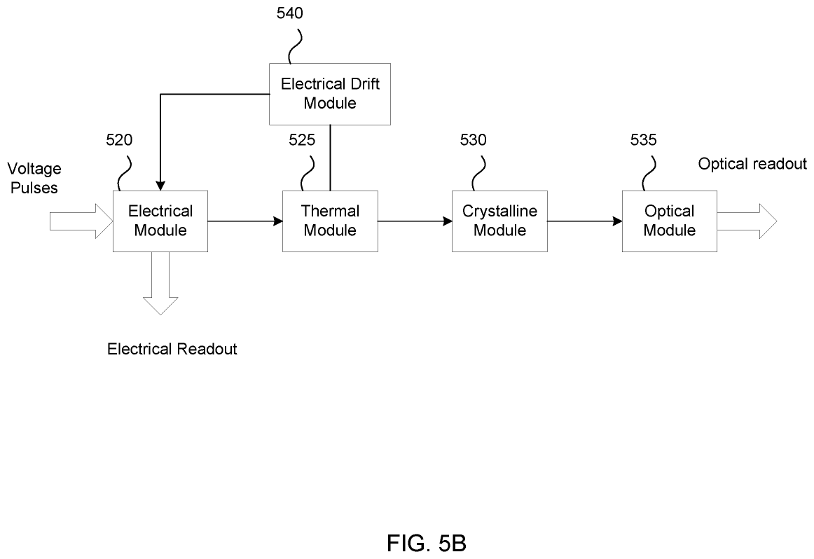

FIG. 5A illustrates a mixed-mode memory element 500, responsive to an electrical switching input signal 505 (also referred to as the write control signal) used to program the state of the mixed-mode memory element. An optical readout operation 510 can be performed to read the state of the mixed-mode memory element by determining the corresponding optical property, and an electrical readout operation 515 can be performed to read the state of the mixed-mode memory element by determining the corresponding electrical property. The structure of FIG. 5A is similar to that of FIG. 3. The memory element can be implemented using a plasmonics approach with a PCM in a nanogap. The PCM is illustrated as particles 517. The state of the PCM causes variability in a resistance 519 and also variability in optical properties.

FIG. 5B illustrates a block diagram of a model which can be used to represent the mixed-mode memory element in the case of a PCM cell structure, for example for analysis or simulation purposes. The model is presented here to elucidate behaviour of the mixed-mode memory element in certain embodiments.

With reference to FIG. 5B, in the electro-optic domain, a change in optical transmission is observed as a result of electrical switching (programming using the write control signal) of the mixed-mode memory element. The physical state of the memory element can be observed in both the optical transmission (optical property) and electrical resistance or conductance (electrical property) which is determined by readout operations. A field-dependent switching mechanism is observed in GST, where a low resistance path is created between two electrodes through a combination of field-induced threshold switching and current-induced Joule heating. The switching mechanism ensures a conductive path is formed (or broken) between the two electrodes, the device resistance is much lower and less variable in the case of electrical switching.

The electrical module 520 of FIG. 5B represents the PCM cell equivalent circuit, and is responsible of generating the cell resistive state at all times. This cell resistive state may represent the stored information, which may correspond to a bit value. The behaviour of the electrical module can be represented by the following equation:

$$\\ ( 1 - {C}_{x} ) \frac{{R}_{off} - {R}_{on}}{{e}^{\frac{{V}_{{M}_{}} - {V}_{t}}{{V}_{0}}} + 1} I$$

Here, Vₜ is the threshold voltage, Rₒₙ and R_{off} are limiting value, V₀ is a parameter determining the shape of a representative current-to-voltage (I-V) curve, and Cₓ is the crystallization ratio of the PCM.

The thermal module 525 of FIG. 5B represents the temperature within PCM the active region using a heat transfer equation, which is based on the cell's resistive state and according to the applied external voltage. The behaviour of the thermal module can be represented by the following equation:

$$\\ {V}_{M} I + δ ( {T}_{r} - T )$$

Here, δ is the dissipation constant and Tᵣ is the ambient temperature.

The crystalline module 530 of FIG. 5B represents the crystalline ratio in the phase change material layer; using the temperature calculated in the thermal module. The behaviour of the crystalline module can be represented by the following equation:

$$\\ α ( 1 - {C}_{x} ) θ ( T - {T}_{x} ) θ ( {T}_{m} - T ) - β {C}_{x} θ ( T - {T}_{m} )$$

Here, α is the dissipation constant, θ(⋅) is the step function, Tₘ is the melting point, and Tₓ is the glass transition point.

The optical module 535 of FIG. 5B represents the photonic near-field switching and optical absorption of PCMs. The behaviour of the optical module can be represented by the following equation:

$$\\ \frac{{ϵ}_{eff} ( {C}_{x} ) - 1}{{ϵ}_{eff} ( {C}_{x} ) + 1} = {C}_{x} X \frac{{ϵ}_{c} - 1}{{ϵ}_{c} + 2} + ( 1 - {C}_{x} ) \frac{{ϵ}_{a} - 1}{{ϵ}_{a} + 2}$$

Here, ϵ is the dielectric function. The refractive indices of partially crystallized PCM may be estimated from effective permittivities approximated by an effective-medium theory, as expressed in the above equation. Values ϵₐ and ϵ_{c} are the permittivities in the crystalline and amorphous states respectively calculated from the refractive indices of GST by \sqrt{ϵ_{λ}}=n+ik.

The drift module 540 represents drifted parameters i.e. the resistance and threshold voltage, based on the empirical laws and drift coefficients extracted from experimental statistical data. The behaviour of the drift module can be represented by the following equation:

$$\\ {R}_{drift} = {{R}_{0} ( \frac{{t}_{off}}{{t}_{0}} )}^{{v}_{r}}$$

Here, R₀ is the device resistance at time t₀ after programming and vᵣ is the drift coefficient.

In a multilevel mixed-mode phase change memory operation, each mixed-mode memory element can be programmed with up to N resistance/optical absorption levels (including fully set, fully reset and intermediate states corresponding to fully crystalline, fully amorphous, and intermediate crystalline/amorphous states). Thus, the memory element can store log₂ N bits, allowing an increased storage density, and hence a lower cost-per-bit. Multilevel operation may be achieved by electrically programming the PCM into intermediate states between the two corner (fully crystalline and fully amorphous) states. Such a mixed-mode memory element can be referred to as a multilevel cell (MLC) storage device or a multilevel phase change memory device. In a PCM device, phase-change materials can be reversibly switched between amorphous and crystalline phase states, each having different electrical resistivity and optical transmissivity.

By using crossings and broadband direction couplers (DC) in an optical crossbar system into which the memory elements are integrated (see below), matrix multiplication can be performed by varying the input light intensities and PCM states in each crossbar accordingly. The summation of multiplications is received at readout in each vertical columns (as presented in more detail below). Parallelized photonic in-memory computing can be achieved using a corresponding mixed-mode PCM crossbar array and other photonic chip-based optical components. In various embodiments, the computation is reduced to measuring the optical transmission of reconfigurable and non-resonant passive components and can operate at a bandwidth, limited only by the speed of the modulators and photodetectors.

In various embodiments, the use of a non-volatile reconfiguration mechanism (the programmable PCM) in a mixed-mode crossbar accelerator adds built-in memory functionality thereby reducing physical footprint. Power consumption is lowered as energy is only needed for switching the memory elements from one state to another, and not for maintaining a particular state. Electrical/photo-tunable phase change and nonlinear chalcogenide semiconductors (alloys of sulphur, selenium and tellurium, traditionally used in DVD's, Blurays® and PCRAM) may provide for a CMOS-compatible implementation and hence may be utilized for the development of improved resistive memories and reconfigurable electro-optic switches. Such embodiments can exhibit a unique combination of direct bandgap, strong spin-orbit coupling and favourable mechanical properties, making them interesting for applications in spintronics, optoelectronics and energy harvesting. Furthermore, development of improved non-volatile phase change memory materials through stoichiometric engineering of chalcogenide semiconductors, while considering the performance metrics such as stability, drift, switching speed, contrast and optical absorption is expected to lead to improved computing architectures.

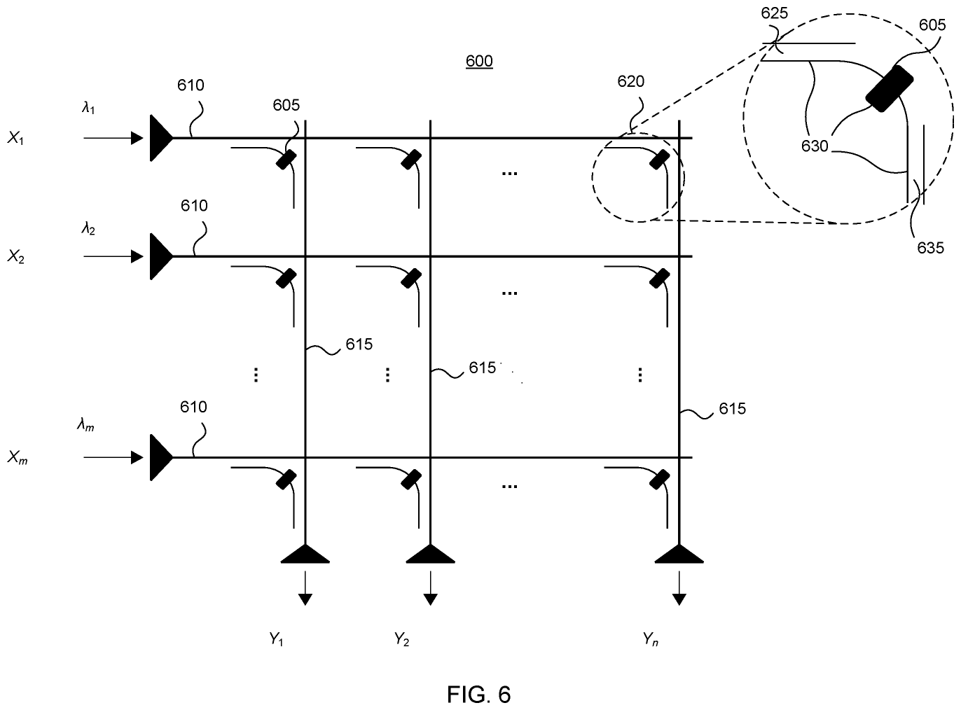

FIG. 6 illustrates a mixed-mode crossbar array apparatus 600 according to an embodiment of the present disclosure. The apparatus 600 employs mixed-mode memory elements 605, such as improved non-volatile electro-optical phase-change memory elements (cells) that may store analog values of a matrix in situ. In various embodiments, the memory elements may be employed as attenuating PCM elements, for example which absorb or otherwise adjust intensity or amplitude of light by a desired amount depending on the particular physical state thereof (e.g. crystalline, amorphous, or an intermediate thereof). This attenuation can be implemented via a controllable optical transmittance of the PCM, by which an intensity of light is controllably adjusted. A different optical transmittance causes a different amount of light to be transmitted (and the rest absorbed, for example), thus adjusting the intensity of light which is output from the PCM and toward the associated output optical coupler. In the crystalline PCM state, most of the incoming light is absorbed, representing for example a “0”, while in the amorphous state, most of the light is transmitted, thus representing a “1”. Intermediate transmission states can be chosen by controllably switching fractions of amorphous and crystalline parts in the PCM cell. The PCM cell can be electrically switched between binary (two) states or multilevel (three or more) states by the application of write control signal voltage pulses with a suitable width and amplitude. A matrix-vector multiplication (MVM) operation may be performed in the optical domain using photonic integrated circuits. Each mixed-mode memory element may be fully addressable in the electrical domain and may be (e.g. simultaneously or sequentially) read out both optically and electrically. This may provide for a new strategy for the development of integrated electro-optical crossbar arrays which addresses the limitations of the current all-electronic and all-optical crossbar array architectures. Reading of a mixed-mode memory element in the optical domain may involve variable optical transmission through the mixed-mode memory element.

In more detail, the apparatus 600 includes a set of input optical waveguides 610 and a set of output optical waveguides 615. There may be one or several input waveguides and output waveguides. Generally, the number of input waveguides is based on the number of columns (or alternatively, rows) of a desired size of matrix to act as a multiplier in a matrix-vector multiplication (MVM), and the number of output waveguides is based on the number of rows (or alternatively, columns) of the desired size of matrix. The input waveguides and output waveguides are conceptually illustrated as forming a crossbar structure, such that each input waveguide forms one intersection with each output waveguide. The waveguides do not necessarily physically intersect, but rather interact via processing components 620. For each input waveguide and output waveguide pair, there is one such processing component, and each processing component includes a respective mixed-mode memory element.

Each input waveguide 610 is configured to receive, as input, and propagate a respective input optical signal, and each output waveguide 615 is similarly configured to propagate and provide, as output, a respective output optical signal. The intensities of the input optical signals can be set to represent elements of a vector which operates as a multiplicand in the MVM. The processing component 620 acts to obtain a portion (e.g. a fixed fraction) of the input optical signal and feed this portion to a mixed-mode memory element 605. An input optical coupler 625 which is operatively coupled to the input waveguide can be used for this purpose, by coupling some or all of the input optical signal onto an optical processing pathway 630. The mixed-mode memory element 605 is also located along the optical processing pathway 630, for example at the output of the input optical coupler 625, so as to receive the coupled portion of the input optical signal. In other words, the input optical coupler “splits off” part of the input optical signal from a corresponding input waveguide, and this split off part is referred to as a portion of the input optical signal. Another input optical coupler adjacent to the same input waveguide can split off another part of the same input optical signal, and this other split off part can be referred to as a second (or third, or fourth) portion of the input optical signal. It is these portions of input optical signals that are fed to and manipulated by the mixed mode memory elements.

The mixed-mode memory element 605 is configured to manipulate the coupled portion of the input optical signal according to the optical property exhibited by the mixed-mode memory element (as previously programmed into same and corresponding to the current persistent state of the memory element). The manipulation can be in the form of an attenuation, absorption or optical transmittance action of the mixed-mode memory element, according to current optical properties of the PCM, for example. The mixed-mode memory element produces an output, which is an optical signal, typically an attenuated version of (or a part of) the portion of the input optical signal that was received by the mixed-mode memory element. In some embodiments, the PCM is evanescently coupled to an optical waveguide structure. The PCM may modify the transmission, reflection or absorption characteristic of the waveguide structure dependent on its state.

Light output by the mixed-mode memory element 605 is received by an output optical coupler 635. Similarly to the input optical coupler, the output optical coupler couples the light that it receives from the mixed-mode memory element onto an associated output waveguide. This light, once coupled onto the output waveguide, forms at least a portion of the output optical signal provided by that output waveguide. Light from multiple output optical couplers in the crossbar array can be fed onto the same output waveguide, where such light is accumulated on the output waveguide to constitute its output optical signal.

The processing component 620 can be considered to include the input optical coupler 625, the mixed-mode memory element 605, the output optical coupler 635, and the optical processing pathway 630. The input and output optical couplers can be directional couplers, contra-directional couplers, or the like, or a combination thereof. Output of a light source such as a laser is coupled to an input waveguide. A portion of this light is coupled onto the processing component via the input optical coupler and thereby to the mixed-mode memory element. Output of the mixed-mode memory element is coupled onto an output waveguide via the output optical coupler.

Multiple input optical couplers 625 can be coupled to a same input waveguide. The coupling ratios (the fractions of light coupled from these input waveguides onto their associated processing pathways) can be set so that each one of the optical processing pathways 630 handles a substantially same or balanced amount of light. Similarly, multiple output optical couplers 635 can be coupled to a same output waveguide, and the coupling ratios can be set so that each one of the optical processing pathways 630 contributes a substantially same portion of light to the output optical signal (all other things, such as input light intensities, being equal).

Output waveguides 615 can accumulate light from all of the processing components 620 coupled thereto. Accordingly, an output waveguide (or a pair of cooperating output waveguides, as will be described below) can produce an output optical signal which represents the result (or part of a result) of a MAC operation. In more detail, each of the mixed-mode memory elements 605 in a given column of the apparatus 600 can be programmed to represent a different respective entry in a row (or column, with transpose operation) of a matrix to be multiplied with a vector. Each of the input waveguides 610 can be provided with an intensity of light which is proportional to (or otherwise representative of) a different respective entry of the vector.

Assuming that the mixed-mode memory element exhibits an optical property which attenuates received light by a programmed amount, each processing component operates to attenuate light by an amount corresponding to a given matrix entry. This attenuation can be provided by way of a controllable optical transmittance of the mixed-mode memory element. Therefore, the intensity of light output by each processing component 620 is equal to the intensity of light input, multiplied by the amount of attenuation. Accordingly, the processing component 620 facilitates a multiplication between a matrix entry and a vector entry. Furthermore, each output waveguide accumulates a sum of light intensities, so that a MAC operation is performed, between elements in a row of a matrix, and elements in a vector. By using multiple such output waveguides, a multiplication between a matrix and a vector is performed.

In this way, the apparatus may be configured to perform a multiplication between a first (e.g. vector) value and a second (e.g. matrix) value. The first value is represented using powers (intensities or input optical amplitudes) of input optical signals, for example as provided by controllable optical signal sources. The second value is represented using controllable optical properties (e.g. optical transmittances) of the mixed-mode memory elements which attenuate parts of these output optical signals. The multiplication involves setting powers (intensities or amplitudes) of the input optical signals and adjusting the input optical signal portions, propagating through the processing components 620, according to the controllable optical properties of the mixed-mode memory elements.

It should be noted that, as will be readily understood by a worker skilled in the art, each input waveguide can receive and propagate light of a different wavelength, in order to inhibit potential back-coupling or cross-coupling effects which would complicate the multiplication. Different output optical couplers are configured to couple different, non-overlapping bands of wavelengths onto the output waveguide. This mitigates bands of wavelengths from “leaking backward” through other output optical couplers. The output optical signal produced by an output waveguide is thus generated based on cumulative outputs of those processing components which are coupled to that output waveguide.

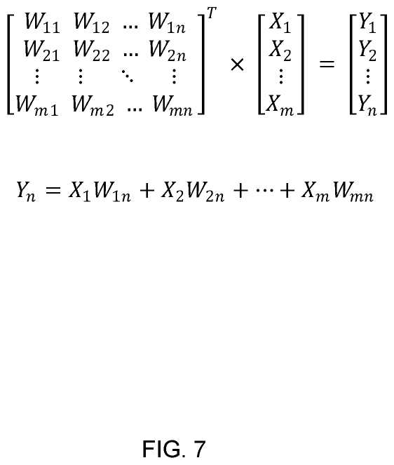

FIG. 7 illustrates a matrix-vector multiplication (MVM) as may be implemented by a photonic operation of embodiments of the present disclosure. The entries Xᵢ of vector X are represented using intensities of input optical signals, as set by optical signal sources, while the entries Wᵢⱼ of matrix A are represented using optical properties of mixed-mode memory elements of the apparatus. The entries Yᵢ of output vector Y, which is the output of the MVM, are represented using intensities of output optical signals as provided by the output waveguides of the apparatus. As shown the MVM is a m×n operation.

In more detail, the input vector X is encoded in the amplitude of the optical signals sent to the different processing components. In addition to amplitude at a given wavelength, the input vector is also encoded at different wavelengths. This may provide the ability for multiple calculations to be carried out simultaneously, while avoiding unwanted interference. The amplitude of each wavelength represents a corresponding one of the entries (X₁, . . . Xₘ) of X. Therefore, input vectors can be fed to the matrix by modulating the input signals with currently available fast electro-optical modulators, providing access to very high data rates. The matrix itself is implemented using a waveguide crossbar array with directional couplers that may equally distribute the input power to all processing components. Using the input optical couplers (625 in FIG. 6), the light indicative of the input vector is equally distributed to the different columns of the matrix. The output optical couplers (635 in FIG. 6) combine the light after interaction with the mixed-mode memory elements (605 in FIG. 6). Multiple output optical couplers couple light onto a same output waveguide. The optical interaction at each mixed-mode memory element implements a multiplication, while the collection of resulting light on a same output waveguide (615 in FIG. 6) and the subsequent aggregate detection by photodetectors implements the accumulation (summation) of several multiplications, thus completing the MAC operation. As mentioned above, the input light can be substantially equally distributed to processing components. Alternatively, the input light can be unequally distributed to processing components. Equal distribution is considered good design practice but is not strictly necessary. It should be noted that each vector entry only interacts with a single mixed-mode memory element per matrix column. This interaction can be viewed as a single multiplication between the incoming amplitude and the absorption or transmittance of the mixed-mode memory element. The output power at each column of the matrix represents the inner-product (the sum of the individual products) of the input vector with a kernel.

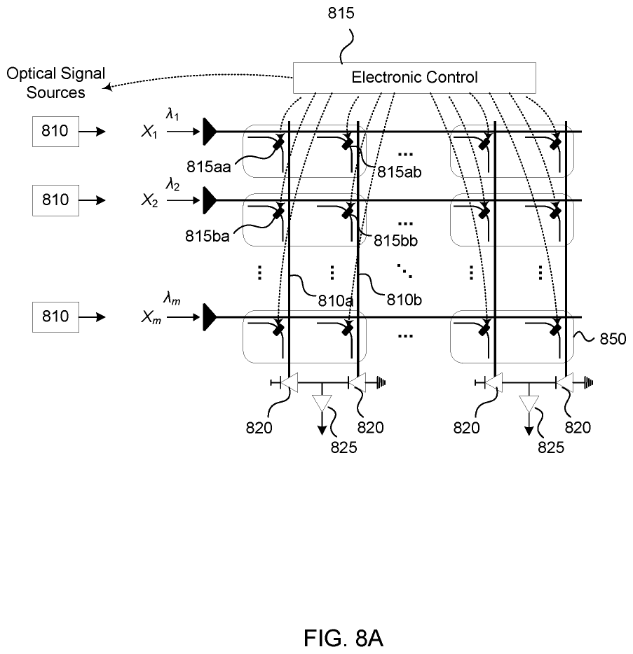

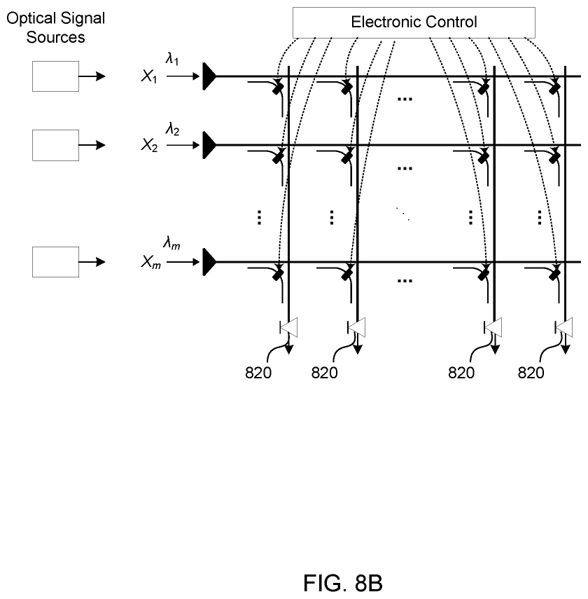

To achieve both positive and negative matrix elements, two PCM elements are coupled together via a balanced photodetector. FIG. 8A illustrates the embodiment of FIG. 6 with the addition of optical signal sources 810 which are operable to provide input optical signals of controllable intensities, for example in order to represent entries of a vector X to be multiplied by a matrix A. The intensities of the optical signals can be set in response to a signal from a controller 815 which may also control the mixed-mode memory elements, e.g. by applying write control signals thereto. That is, the controller can direct the optical signal sources to produce optical signals of a specified intensity or amplitude. FIG. 8A further illustrates part of a readout device which includes photodetectors 820 operatively coupled to output waveguides, where each photodetector is configured to generate an (electrical, analog) output signal indicative of total intensity of the output optical signal. The photodetector in this sense operates as an optical to electrical transducer. The readout device as a whole may be configured to generate an output signal based on total intensity of the output optical signals of one or more output waveguides. Because total intensity is used, the photodetector can accumulate intensities of optical signal portions in different wavelength bands. Each photodetector may be a photodiode, for example. The photodetector may be substantially equally responsive across a band of wavelengths which covers all the wavelengths of the input optical signals.

As shown in FIG. 8A, the photodetectors 820 can be paired together to implement balanced photodetectors. Each balanced photodetector is coupled to a transimpedance amplifier 825. As will be readily understood by a worker skilled in the art, the balanced photodetectors operate together to output a signal which is indicative of a difference between intensities of light of the two output waveguides to which the balanced photodetectors are coupled. That is, each balanced photodetector generates an indication (an output signal) of a difference between a pair of output optical signals, provided by a respective pair of output waveguides. The transimpedance amplifier 825 serves to convert this difference into an appropriate output signal. The output signal may be an analog electrical signal produced by the photodetector/transimpedance amplifier circuit in response to the optical signal(s) provided thereto.

Accordingly, signed (negative or positive) matrix entries can be implemented as follows. In order to represent a signed value Wᵢ, two respective mixed-mode memory elements are programmed with values aᵢ and bᵢ, such that Wᵢ=aᵢ−bᵢ. (Values Wᵢ may be entries in the matrix A in the MVM Y=AX.) For example, memory element 815aa is set with value a₁, memory element 815ab is set with value b₁, memory element 815ba is set with value a₂, and memory element 815bb is set with value b₂. Accordingly, two processing components are configured to attenuate two respective portions of a same input optical signal by two different factors, aᵢ and bᵢ. Processing components are thus operated in pairs, for example as shown by oval 850. This allows the apparatus to photonically multiply two values, one of which is a signed value represented by a difference between a first factor and a second factor, and the other of which is represented by an intensity Xᵢ of an input optical signal. The balanced photodetector made of photodetectors 820 receives, from a first output waveguide 810a, light having a total intensity of a₁X₁+a₂X₂. The balanced photodetector receives, from the second output waveguide 810b, light having a total intensity of b₁X₁+b₂X₂. The balanced photodetector then provides an output signal indicative of a difference between these two total intensities, that is a₁X₁+a₂X₂−(b₁X₁+b₂X₂)=W₁X₁+W₂X₂.

FIG. 8B illustrates an alternative in which the photodetectors 820 are not operated in balanced pairs. Other details of FIG. 8B are substantially the same as FIG. 8A, except that mixed-mode memory elements are not operated pairwise to represent signed values. Accordingly, positive matrix entries are represented. Negative matrix entries can be represented by performing two different MAC operations and combining the results, for example. In some embodiments, an apparatus can be switched between the configurations of FIGS. 8A and 8B by means of controllable switches which selectably cause photodetectors to operate either in balanced pairs as in FIG. 8A or individually as in FIG. 8B. In FIG. 8B, the optical readout device determines intensity of each output optical signal provided by each output waveguide. As illustrated, the optical readout device includes a dedicated photodetector having suitable bandwidth, coupled to each output waveguide. The outputs of the photodetectors are electrical output signals which indicate the total intensity of light of the corresponding output optical signal, as provided by the crossbar array. These electrical output signals accordingly indicate results of a MAC operation involving a row (or column) of matrix A and vector X.

In general, optical signals are read by single or balanced photodetectors along with components such as a transimpedance amplifier (TIA). Photodetectors convert the optical output signals to representative electrical signals via electro-optical conversion. A TIA can convert the photodetector output current signal to a suitable voltage signal for processing by subsequent analog circuits, digital circuits, or combinations thereof. In some embodiments, an analog processing unit processes these electrical analog signals, calculates an error function and propagates the error values across the crossbar apparatus. This is possible because the crossbar apparatus can operate in both optical and electrical modes. A programming block may update the weight values based on the backward propagated error signals in the electrical domain.

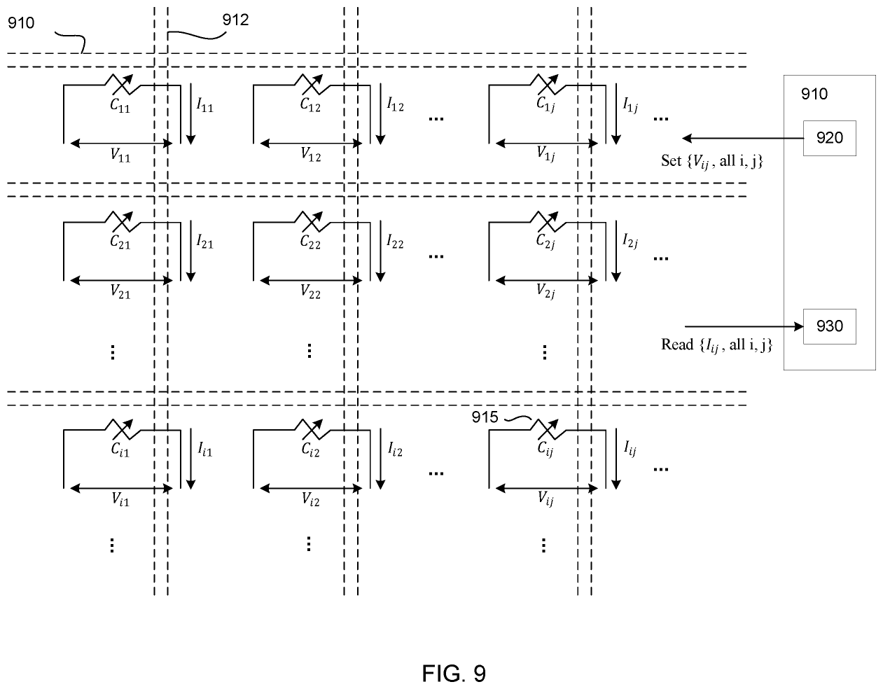

FIG. 9 illustrates an electrical readout circuit 910, as previously described. The electrical readout circuit interacts with the mixed-mode memory elements 915 to provide one or more electrical readout signals. The electrical readout operation can involve determining the resistance (or conductance) of the mixed-mode memory element for example via application of a low-voltage pulse. In FIG. 9, each mixed-mode memory element 915 is represented for convenience as a programmable resistor having conductance Cᵢⱼ. The positions or mixed-mode memory elements 915 in FIG. 9 can be the same as the positions of the mixed-mode memory elements 605 in FIG. 6. That is, for each value i and j, the mixed-mode memory element 605 in the i^{th} row and j^{th} column in FIG. 6 (i.e. having conductance Cᵢⱼ) may be the same as the mixed-mode memory element 915 in the i^{th} row and j^{th} column in FIG. 9. Optical input waveguides 910 and optical output waveguides 912 are shown for reference. The electrical readout circuit includes controllable voltage sources 920 and a result collection circuit 930. The result collection circuit includes analog electronics and may also include digital electronics. Operations such as determining sums and differences of received currents (or voltages) can be performed in the analog or digital domain. As will be described later, such operations can be performed in support of backpropagation operations to facilitate (e.g. neural network) machine learning.

In operation, the electrical readout circuit 910 operates the controllable voltage sources 920 to cause voltages Vᵢⱼ to be applied across corresponding mixed-mode memory elements. These voltages can be representative of values in a MAC operation. The result of applying voltage Vᵢⱼ to a mixed-mode memory element having conductance Cᵢⱼ is a current Iᵢⱼ=VᵢⱼCᵢⱼ. Each individual current thus represents a result of one multiplication in the MAC operation. By adding currents (or indications of said currents) together using the result collection circuit 930, the MAC operation is completed. Thus, different voltages Vᵢⱼ (for different values i,j) are applied to different mixed-mode memory elements, each having a different conductance Cᵢⱼ. The electrical outputs (currents Iᵢⱼ) are read (individually or collectively). Via the equation Iᵢⱼ=VᵢⱼCᵢⱼ, these electrical outputs vary in accordance with the voltages and the conductances (or the reciprocal, resistances).

When signed matrix entries are represented for example as in FIG. 8A, the result collection circuit 930 can be configured to perform a combination of additions and subtraction in order to complete the MAC operation. For example, when, for odd-numbered values of j, a given signed value W is represented as Cᵢⱼ−Cᵢⱼ₊₁, then Vᵢⱼ can be set equal to Vᵢⱼ₊₁ and the result collection circuit can determine Iᵢⱼ−Iᵢⱼ₊₁ in order to compute the multiplication result Iᵢⱼ−Iᵢⱼ₊₁=VᵢⱼW. The signed value W is analogous to the signed weights discussed previously with respect to the optical computation, and can be derived from mixed-mode memory elements similarly. Such a subtraction can be performed for each pair of mixed-mode memory elements which operate together to encode a signed valued. The subtractions can be performed individually or in groups. For example, a first set of currents can be added together to produce a first result, a second set of currents can be added together to produce a second result, and the second result can be subtracted from the first result.

In other words, the electrical readout circuit can perform an electrical interaction with the mixed-mode memory elements to produce electrical readout signals. The electrical readout signals vary with the combined electrical properties of the mixed-mode memory elements. The electrical interaction can include electrically interacting with some mixed-mode memory elements to produce one or more first electrical readout signals, electrically interacting with other mixed-mode memory elements to produce one or more second electrical readout signals, and generating a difference between the first and second electrical readout signals.

In some embodiments, the same set of voltages can be applied to each row of mixed-mode memory elements. That is, for each j, V₁ⱼ=V₂ⱼ= . . . =Vⱼ. In other words, the electrical readout circuit can be configured to perform a plurality of vector multiplications where the same vector is used in every multiplication. Each vector multiplication is between one row of mixed-mode memory elements (i.e. a set of mixed-mode memory elements coupled to a same input waveguide) and a vector V represented by voltages (V₁, V₂, . . . ) with Vⱼ as defined above. Such embodiments can be useful for example when implementing (e.g. neural network) machine learning. Therefore, an electrical readout circuit can be divided into multiple sub-circuits. Each sub-circuit can interact with mixed-mode memory elements of a same row (i.e. coupled to a same input waveguide). In this way, a sub-circuit can produce an electrical readout circuit which varies with combined properties of the mixed-mode memory elements with which it interacts. Different sub-circuits can operate concurrently.

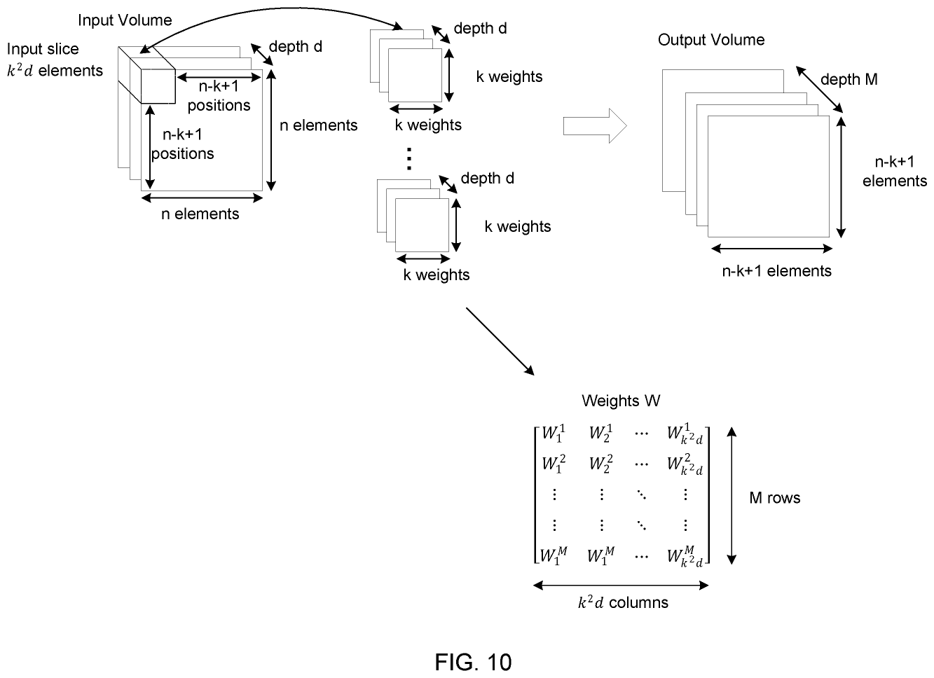

Embodiments of the present disclosure include performing operations, using the apparatus, in support of machine learning operations. An example of machine learning operations is training (e.g. according to supervised learning) a convolutional neural network. FIG. 10 schematically represents implementation of a synaptic layer of a convolutional neural network. The input volume to the synaptic layer can be an input training example (e.g. an image of n pixels by n pixels and depth d corresponding to d different color components of the image), or the neuron activations from a preceding neuron layer of dimensions n×n×d neurons. The synaptic layer comprises M weight kernels, each comprising a volume of k×k×d weights as illustrated in FIG. 10. Weighted signals are generated by sliding each kernel through positions of the input volume. At each position, a dot product is computed over the kernel weights and signal elements at corresponding locations in the k×k×d slice of the input volume. With a stride of 1, each kernel can slide through (n−k+1) positions both horizontally and vertically in the input volume to produce one plane of the output volume shown on the right of the figure. The complete output volume for all M kernels thus has dimensions (n−k+1)×(n−k+1) and depth M. The elements of this output volume are mapped to neurons in the next layer for further processing. The set of weights {w} for the M kernels of the convolutional layer can be represented by a matrix W having M rows and k²d columns as indicated in FIG. 10. The weighting computation can be implemented as a matrix-vector multiplication Wₓ between the matrix W (which may be part of or which may include matrix A) of weights and a vector X of the k²d signals in each slice of the input volume. The entire computation consists of (n−k+1)² of these matrix-vector multiplications for the (n−k+1)² slices of the input volume.

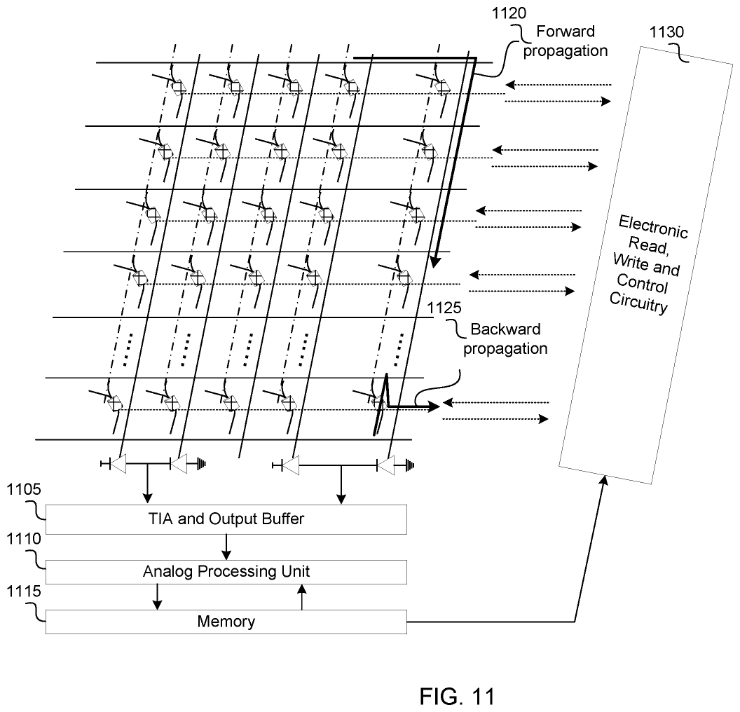

FIG. 11 illustrates implementation of an embodiment of the present disclosure in performing forward and back propagation for supporting machine learning of the type illustrated in FIG. 10. The machine learning may correspond to a neural network training operation. A forward propagation operation occurs in the optical domain and a backward propagation operation occurs in the electrical domain. By sending electrical switching- and readout-pulses consecutively, arbitrary transmission states of the mixed-mode memory elements can be achieved limited only by the noise of the readout circuit. The entries in a weight matrix are assigned by controlling the states of the mixed-mode memory elements. Mixed-Mode Photonic in-memory computing brings wavelength division multiplexing as an additional degree of freedom, potentially enabling multiple MVM operations in a single time step. Wavelengths can be multiplexed and demultiplexed accordingly before and after the matrix again using fiber-multiplexers. The convolution results may be read using high-speed photodetectors and processed in the electrical domain by a Transimpedance amplifier (TIA) 1105, an analog Processing Unit 1110 and other peripheral analog/digital circuits. A memory 1115 such as an analog memory may also be coupled to the APU. The analog processing unit (APU) may be adapted to generate signals propagated by the neuron layers in the propagation operations and to perform weight-update calculation operations. Neural network training involves an iterative cycle of signal propagation and weight update calculation operations. In response to each network input, neuron activation signals are forward-propagated 1120, and errors are computed, for example by the APU, by comparing the network output signals to the expected network output for the input training example. The resulting error signals are then back-propagated 1125 in electrical domain through the network. Updates to the weights are calculated based on the activation and error signals propagated by the neuron layers in this signal propagation operation. At least the back-propagation can be performed by electronic read, write and control circuitry 1130, which may couple to the memory 1115. The electronic read, write and control circuitry 1130 may control optical signal sources, control electrical read and write operations associated with the mixed-mode memory elements, and other tasks, such as controlling the ordering of operations.

The forward propagation operation involves optically interacting with the mixed-mode memory elements via the input waveguides, output waveguides, and optical readout device, and associated components such as the controller. A vector X corresponding to training data is multiplied with a matrix A comprising neural network weight values.

Following, or as part of, the forward propagation operation, the output of the optically performed multiplication is processed to determine a set of errors. The errors are based on a difference between the output of the multiplication and an expected outcome of the multiplication. In some embodiments, each one of the outputs of the multiplication can be compared with a corresponding component of the expected outcome, and the set of errors can be generated based on the comparing, such that the set of errors includes a separate error for each one of the outputs. The set of errors can be generated for example by the analog processing unit. The expected outcome can be given as part of supervised machine learning training data (e.g. a desired output of a neural network).

The backward propagation operation involves electrically interacting with the mixed-mode memory elements using the electrical readout circuit and associated components such as the controller. The backward propagation operation involves multiplying, by electrical interaction with the mixed-mode memory elements, each row of the matrix A by a vector which encodes the set of errors. The backward propagation operation thus performs a multiplication between a set of errors and values represented by states of the mixed-mode memory elements. As illustrated, a path for the backward propagation operation 1125 involves an electrical read signal being sent to a mixed-mode memory element, for example in the form of a voltage, and a resulting signal, such as a current, being sent to the circuitry 1130. The circuitry 1130 can further configure and apply the electrical read signal being sent to the mixed-mode memory element.

Accordingly, in some embodiments, the set of errors are provided to a control circuit operatively electrically coupled to the mixed-mode memory elements. The control circuit then causes the electrical readout circuit to apply a set of readout electrical signals based on the generated set of errors. Each of the set of readout electrical signals represents one of the set of errors. The electrical readout circuit is configured to produce an output indicative of a multi-component multiplication between the set of errors and the values programmed into the mixed-mode memory elements (and expressed via the electrical properties thereof). This can be referred to as a second multiplication.

The result of the backward propagation operation in a neural network training operation indicates weighted errors. The neural network can be adapted based on the weighted errors. Accordingly, embodiments of the present disclosure involve reprogramming the mixed-mode memory elements based on the result of the backward propagation operation. The electrical readout circuit can apply a set of readout electrical signals based on a generated set of errors. Each of the set of readout electrical signals can represent an error from the set of errors. The electrical readout circuit may be configured to produce an output indicative of a multi-component multiplication between the set of errors and a set of values programmed into the mixed-mode memory elements (and expressed via electrical properties thereof, e.g. conductance or resistance, as explained elsewhere herein). The set of errors can be the voltages Vᵢⱼ which cause a resulting current Iᵢⱼ, thus implementing the multiplication via Iᵢⱼ=VᵢⱼCᵢⱼ as discussed above.

Training of the neural network is typically repetitive. Therefore, embodiments of the present disclosure involve iteratively repeating the forward propagation operation, the backward propagation operation, and the reprogramming multiple times, for example based on different instances of training data in a supervised learning scheme. The forward propagation operation may be performed for multiple neuron layers in an artificial neural network, from the first neuron layer to the last neuron layer. In backpropagation signals may be propagated backward through the network in a reverse order, for example from a last neuron layer to a first neuron layer. Output signals resulting from forward propagation may be compared with expected output signals for a current training example in order to determine an error signal for the relevant neuron. Error signals for the output layer neurons may be backpropagated through all layers of the neural network, weighted by appropriate weights as stored in the crossbar array mixed-mode memory elements of the interposed neuron layers. Backpropagation may thus result in computation of error signals for each neuron layer. Updates to weights of each layer may then be calculated based on signals propagated by the neuron layers.

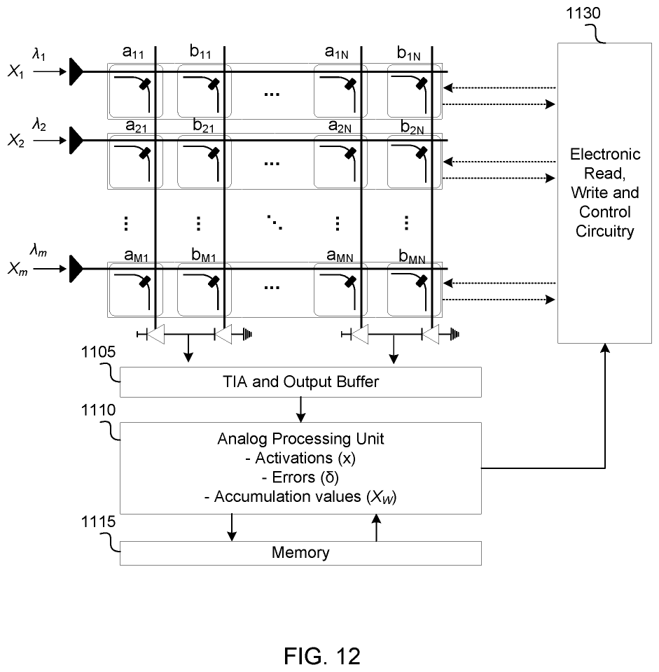

FIG. 12 illustrates an apparatus according to an embodiment of the present disclosure, including a mixed-mode crossbar array integrated with an analog processing unit 1110, embedded memory 1115, and electronic read, write and control circuitry 1130. High-speed balanced photodetectors and transimpedance amplifiers 1105 are also included. Output buffers may be provided with the transimpedance amplifiers to buffer signals from the transimpedance amplifiers. This apparatus can be used to support convolutional neural networks. The electronic read, write and control circuitry repeatedly programs the mixed-mode memory elements to update the neural network weights as stored in the mixed-mode memory elements, in dependence on the accumulation value for that weight. Optical signals related to training data are provided to the input waveguides. The crossbar array stores artificial neural networks (ANN) weights in respective mixed-mode memory elements. The mixed-mode memory elements are thus operated for receiving and weighting the signals to implement the synaptic layers of the network. The conductance states aᵢⱼ, bᵢⱼ, which pairwise make up weights Wᵢⱼ stored in the mixed-mode memory elements can be adjusted during training by application of programming (write control) signals. The write operation can involve switching a mixed-mode memory element between states (e.g. amorphous and crystalline states or intermediates thereof) via application of an electrical pulse. The optical weighted signals from a synaptic layer are fed to photodetectors for optical to electrical conversion. Photodetector output is interfaced with the Analog Processing Unit (APU) which then generates the signals for propagation to the next neuron layer. The APU can also generate the activation and error signals propagated by the neuron layers in the forward and backpropagation operations and perform the weight-update calculations of the on-chip training operation.

Potential advantages of such embodiments are as follow. The throughput of an example embodiment is 140 TOPS or 160 TOPS (e.g. depending on the size of the crossbar array), which is significantly higher than that of comparable devices such as the crossbar arrays recently proposed in Feldmann, Johannes, et al. “Parallel convolution processing using an integrated photonic tensor core.” arXiv preprint arXiv:2002.00281 (2020) (4 TOPS) and Miscuglio, Mario, and Volker J. Sorger. “Photonic tensor cores for machine learning.” Applied Physics Reviews 7.3 (2020): 031404, (2 TOPS for Electronic Data and 64 TOPS for Optical data). The value of 160 TOPS can be achieved for example for a 64×64 crossbar array and a 20 GHz TIA bandwidth, with wavelength division multiplexing. The throughput is dependent on the bandwidth of the photodiode and transimpedance amplifier (for O/E conversions) and hence can be further improved by developing state-of-the art photodiode and electronic peripheral circuits. The energy efficiency of an example embodiment is around 50 TOPS/W, which is significantly better than that of the crossbar array proposed by IBM/Oxford (5.2 TOPS/W) and George Washington University (0.1 TOPS/W for Electronic Data and 4 TOPS/W for Optical data). The improved energy efficiency is believed to be at least in part because of the minimal usage of data converters (ADCs/DACs) in the processing circuitry. Also, no additional laser sources and laser drivers are necessarily required to change the state of the mixed-mode PCM devices. The energy efficiency might be further improved if the design is scaled down to lower CMOS process nodes such as 5 nm. The effective footprint of an example embodiment could be reduced to a significant extent as no additional laser sources are necessarily required to change the state of the PCM devices. This may also lead to improvement in the energy efficiency. Embodiments involving a 3D or 2.5D stacked integrated design leads to a compact and modular system. The mixed-mode design approach may lead to better flexibility in terms of tuning the weight precision.

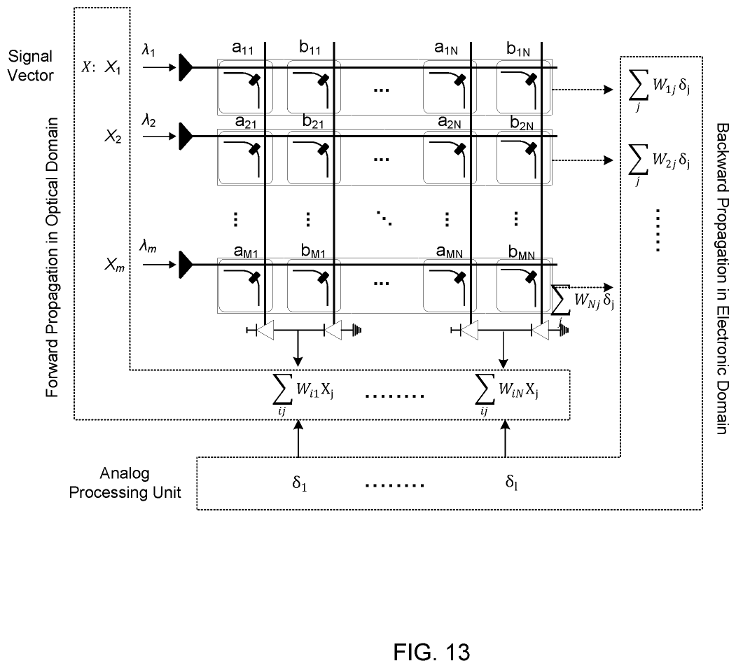

Embodiments of the present disclosure provide for a method and apparatus for implementing an artificial neural network in a training program. The training program involves a backpropagation operation for calculating error signals for neuron layers, and performing weight-update calculations. As previously mentioned, forward propagation occurs in the optical domain, i.e. via optical interaction with the mixed-mode memory elements, while backward propagation occurs in the electrical domain, i.e. via electrical interaction with the mixed-mode memory elements. FIG. 13 illustrates a crossbar apparatus having input waveguides, output waveguides, processing components including mixed-mode memory elements, and balanced photodetectors. Control electronics are not shown in detail but it is considered that an analog processing unit may be utilized. The embodiment implements signed weights as discussed with respect to FIG. 8A. In a forward propagation operation, input optical signals (X=(X₁, X₂, . . . ) are supplied to the input waveguides of the crossbar array, as shown in FIG. 11. The resulting output optical signal provided by the i′ output waveguide corresponds to weighted sums ΣᵢaᵢⱼXᵢ or ΣᵢbᵢⱼXᵢ Taking neural network weights as Wᵢⱼ=aᵢⱼ−bᵢⱼ, the outputs of balanced photodetectors become ΣᵢWᵢⱼXᵢ. The apparatus thus implements the MVM for the neural network forward propagation operation. Next, for each index j, error signals δⱼ are computed based on the outputs ΣᵢWᵢⱼXᵢ. The computation can be performed by an analog processing unit, for example. The error signals δⱼ are indicative of a difference between the outputs ΣᵢWᵢⱼXᵢ and expected values of such outputs, based on the training data. For example, labels associated with the training data can be used to generate indications of the expected values. Backpropagation computation can be performed by supplying electronic error signals δⱼ as input to the electrical readout circuit to obtain the weighted error sums ΣⱼWᵢⱼδⱼ as electrical readout signals. Voltages indicative of the error signals δⱼ can be provided as inputs to the electrical readout circuit in order to electrically perform a MAC operation, by electrically interacting with the mixed-mode memory elements. The electrical interaction has already been described herein. The weights can then be updated based on the weighted error sums. In some embodiments, the weight update is given by ΔWᵢⱼ=ηYᵢδⱼ, which may be computed by the analog processing unit. Value Yᵢ is defined below. Thus, the mixed-mode memory elements are programmed, e.g. as part of a neural network training operation, based on the electrical readout signals, which in turn are based on the outputs of the optical readout device (e.g. involving the balanced photodetectors).

The analog processing unit (APU) implements weight-update calculation operations to calculate updates to respective weights stored in the mixed-mode crossbar array in dependence on signals propagated by the neuron layers. For each weight w in the set {w}, the APU accumulates the updates calculated for that weight in an accumulation value Y_{w} for that weight. The APU integrates circuits that periodically programs the PCM devices storing each weight w to update the stored weight in dependence on the accumulation value Y_{w} for that weight. The update ΔWᵢⱼ to a weight Wᵢⱼ between a neuron i in one layer and a neuron j in the next layer can be calculated as:

$$\\ Δ {W}_{ij} = η {Y}_{i} {δ}_{j}$$

where, Yᵢ is the forward-propagated activation signal from neuron i, δⱼ is the back-propagated error signal from neuron j and η predefined learning parameter for the network.

The accumulation value Yᵢⱼ for each weight Wᵢⱼ is updated as:

$$\\ {Y}_{ij} = {Y}_{ij} + η \sum ( {Y}_{i} {δ}_{j} )$$

Whether an accumulation value Y has a single or double subscript depends on context—subscript value i or w can indeed be a particular two-element value ij. The analog processing unit (APU) is adapted to generate the activation and error signals propagated by the neuron layers in the forward and backpropagation operations, and to perform the weight-update calculations of the training operation. The APU also includes a programming circuit for programming devices in mixed-mode crossbar arrays. The APU also comprises an integrated analog memory. The APU also stores the operating data such as the activation signals Y and error signals, as well as accumulation values Y_{w}. Updates to each individual weight w are calculated and accumulated in a single accumulation value Y_{w}, and the array is periodically programmed to update the stored weights based on the accumulation values.

Physically speaking, and in support of a neural network implementation for example, embodiments of the disclosure involve programming mixed-mode memory elements of a crossbar array to represent values of a multi-component multiplier, such as a matrix holding neural network weight values. A set of input optical signals are then provided to input optical waveguides of the crossbar array. Each input waveguide is configured to propagate a respective input optical signal and the set of input optical signals indicate a multi-component multiplicand to be multiplied by the multiplier. As discussed above, the crossbar array is configured to cause the input optical signals to interact with the mixed-mode memory elements to generate output optical signals, provided by output waveguides, which are indicative of a result of the multiplication. The above multiplication can correspond to a forward propagation operation in a neural network training operation. By way of definition, a “readout device” receives optical output signals and provides electrical output signals (“output”) indicative of the optical output signals. In contrast, an “electrical readout circuit” electrically interacts with the set of mixed-mode memory elements to produce corresponding electrical readout signals. These electrical readout signals vary based on the electrical properties of the mixed-mode memory elements, and thus are indicative of such electrical properties as well as the contents of the memory elements.

In some embodiments, the electrical readout circuit can interact with contents of the mixed-mode memory elements in such a way that a MAC operation is performed. In particular, the readout device can produce a vector (or matrix) output, and this vector output can be used to generate a first vector (or matrix) in the MAC operation to be performed. A second vector (or matrix) in the MAC operation to be performed can be supplied as contents of the mixed-mode memory elements. This MAC operation can correspond to a backpropagation operation in a neural network training operation. Furthermore, the electrical readout signals can be used to update the mixed-mode memory elements. For example, the MAC (backpropagation operation) which is performed by the electrical readout circuit can generate electrical readout signals which are used to update neural network weights as stored in the mixed-mode memory elements.

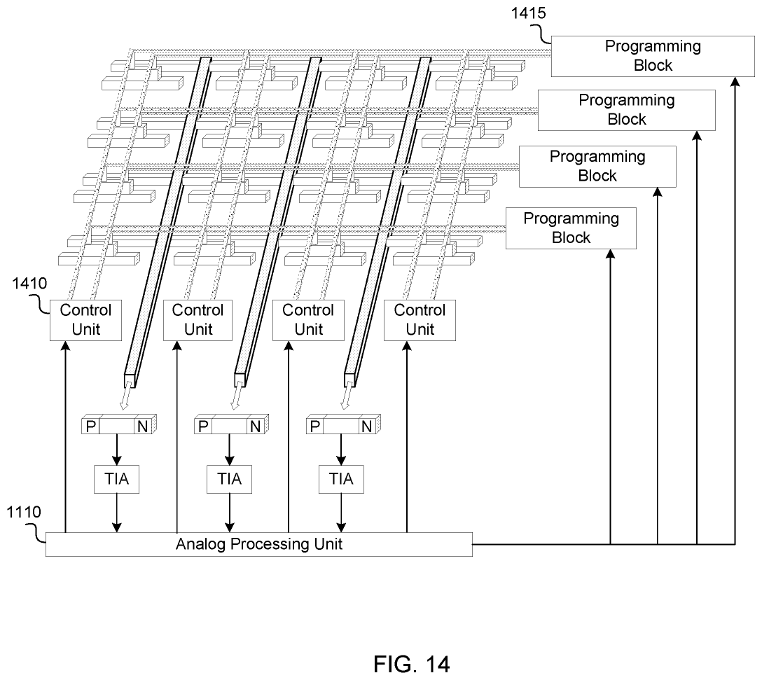

In various embodiments, the apparatus is configured, for example using the APU, to generate signals propagated by the neuron layers in propagation operations and to perform weight—update calculation operations. Neural network training involves an iterative cycle of signal propagation and weight update calculation operations. In response to each network input, neuron activation signals are forward-propagated, and errors are computed by comparing the network output signals to the expected network output for the appropriate input training example. The resulting error signals are then back-propagated in the electrical domain through the neural network. FIG. 14 illustrates an apparatus according to embodiments of the present disclosure, with APU 1110, control units 1410 and programming blocks 1415. The apparatus can be provided on a hardware chip or a combination of chips. Updates to the neural network weights (stored in the mixed-mode memory elements) are computed based on the activation signals and error signals propagated by the neuron layers in signal propagation operations. The weight updates are performed by the programming blocks 1415, as directed by the APU 1110. Thus, the programming blocks and control units may be aspects of (or equivalent to aspects of) the electronic read, write and control circuitry.

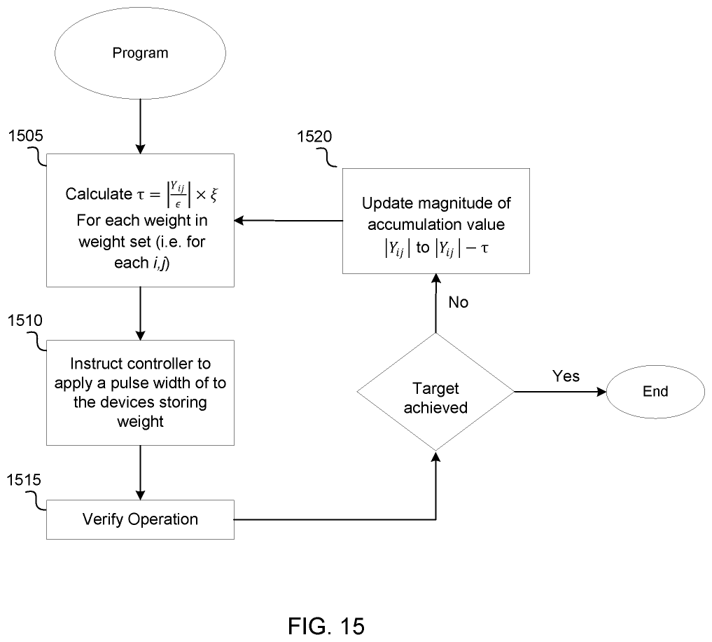

FIG. 15 illustrates steps in a programming operation to update the weights held in the mixed-mode memory elements in a neural network training implementation, according to an embodiment of the present disclosure. For each weight, the programming block calculates 1505 the width of programming pulse, t, to be applied to the mixed-mode memory elements (e.g. as PCM devices) in the crossbar array storing that weight. The width τ is dependent on the accumulation value Yᵢⱼ for the weight Wᵢⱼ. Indices i,j are indices of the elements in the crossbar array. Width t is calculated as follows:

$$\\ τ = \vert \frac{{Y}_{ij}}{ϵ} \vert \times ξ .$$

Here, ∈ is a predetermined step-size indicative of weight-change of a PCM device in response to application of the shortest programming pulse of width ξ. The programming block may include a high-voltage driver that applies programming pulses to the mixed-mode memory elements storing Wᵢⱼ in the array in parallel. Programming pulses can be potentiation pulses (to increase Wᵢⱼ for positive weight updates). Programming pulses can be depression pulses (to decrease Wᵢⱼ for negative weight updates). The programming operation includes instructing 1510 the controller to apply a programming pulse of width τ to the appropriate mixed-mode memory element. A verification 1515 can follow to determine if the target value is achieved. If not, a magnitude of the accumulation value Yᵢⱼ can be updated 1520 (decremented by τ) and the process can be repeated.

If the width of the pulse is fixed and it is required instead to generate a variable number of pulses, then the APU can also calculate the number N of the programming pulses to be applied as:

$$\\ N = \vert \frac{{Y}_{ij}}{S} \vert$$

where, S is the predetermined step-size indicative of weight-change of a PCM device in response to application of one programming pulse.

Embodiments of the present disclosure facilitate backpropagation within the crossbar array for implementing of an artificial neural network (ANN). A direct electronic path for backpropagation and implementation of training algorithms for ANN is provided. A potential advantage of such embodiments is that inherent operations can be exploited utilizing efficient light matter interactions, avoiding cumbersome domain conversion and lowering overall power consumption. Another potential advantage is high speed, for example in that a ns-fast inference may be implemented. Embodiments may be employed to support tasks such as deep learning training, principal component analysis, solving linear and partial differential equations, compressed sensing, random number generation, reservoir computing, associative memory, image filtering and compression, combinatorial optimization, deep learning inference, spiking neural networks, and sparse coding.

According to some embodiments of the present disclosure, neuromorphic computing is mapped onto binary or multilevel mixed-mode memory elements, such as PCM devices. This can be performed in order to encode synaptic weights into an n-bit binary representation, which is stored as a weight on up to n devices, rather than on a single analog device. Thus, a higher precision mixed-mode memory element may be replaced with multiple lower precision mixed-mode memory elements.

Some embodiments represent a multi-bit weight (high-precision) with a single mixed-mode memory element. However, in practice, representing a high-precision weight within a single mixed-mode memory element may incur significant programming overhead, peripheral area, and noise uncertainty. Therefore, in other embodiments, binary or low-precision mixed-mode memory elements are combined together to realize a high-precision aggregate memory element. To implement this, a single multi-bit value may be bit-sliced and stored on multiple binary or low-precision mixed-mode PCM devices. The mapping of mixed-mode photonic neural network architectures can be realized on binary/low-precision PCM devices.

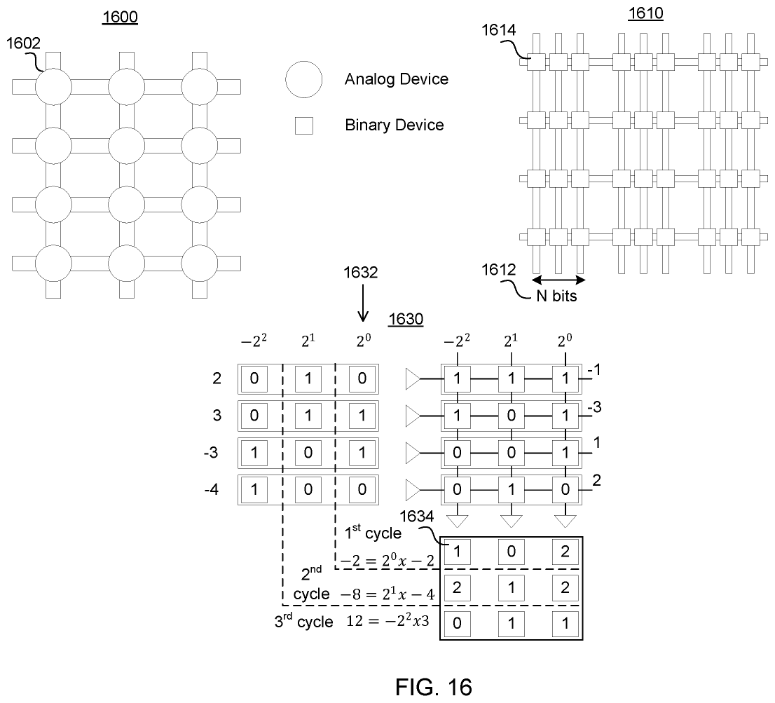

For example, FIG. 16 shows how values (e.g. weights) can be encoded into an N-bit binary or low-precision format and then stored in N lower-precision mixed-mode memory elements instead of one higher-precision mixed-mode memory element. The upper left drawing 1600 illustrates a crossbar array in which the mixed-mode memory elements of the photonic components 1602 are single “analog” devices which are configurable into a significant number of states, sufficient for storing many potential values. The upper right drawing 1610 shows N columns 1612 of memory elements are used, these N columns 1612 being equivalent to one column 1602 in the upper left drawing 1600. In particular, each memory element 1602 is replaced by three cooperating memory elements 1614. Each memory element 1614 in a column can be a “binary” element capable of storing only two values, denoted ‘0’ and ‘1.’ For example, in a PCM device such an element can be switchable between fully crystalline and fully amorphous states, but not configurable into any intermediate state. Accordingly, N columns of memory elements in FIG. 16 are equivalent to one column of a higher-precision memory element capable of being placed into any one of 2^{N} states. Furthermore, quantized weights may be used to facilitate reducing the value of N. The output of each column shows the sum of product of input current and binary weights of the column and after performing scaling, the output of N columns are added to obtain equivalent analog dot-product. Similarly, multiple low-precision devices (2/3/4 bit) can be combined in order to achieve a high weight resolution (8 bit-16 bit). See for example Zidan, Mohammed A., et al. “Field-programmable crossbar array (FPCA) for reconfigurable computing.” IEEE Transactions on Multi-Scale Computing Systems 4.4 (2017): 698-710.

Accordingly, in embodiments of the present invention, multiple mixed-mode memory elements can be operated together to indicate a single weight. This is shown for example in FIG. 8A where contents of two mixed-mode memory elements together indicate a single weight, and in FIG. 16, where contents of multiple mixed-mode memory elements together indicate a weight by combining contents. Different mixed-mode memory elements can indicate different parts of a weight, such that when the contents are added together (or subtracted, or a combination thereof) the weight is indicated with adequately high precision.

In more detail, referring to FIG. 16, the bottom drawing 1630 illustrates computing an inner product of input vector [2, 3, −3, 4] with a weight vector [−1, −3, 1, 2]. The weight vector is represented by contents of the mixed-mode memory elements. More particularly, each entry in the weight vector is represented by three mixed-mode memory elements each capable of storing a binary ‘0’ or ‘1’ value. In a first step, each entry ν in the weight vector is represented in a three-bit signed fixed point format. That is, values b₁, b₂ and b₃ are determined such that:

$$\\ \begin{matrix}v = - {2}^{2} {b}_{3} + {2}^{1} {b}_{2} + {2}^{0} {b}_{1} . & ( 1 )\end{matrix}$$

For example, for ν=−1, b₁=1 b₂=1 and b₃=1. The entries in the input vector can be represented similarly. Binary representations of each entry in the input vector and weight vector are illustrated. Specifically, ν=−1 maps to b₁=1 b₂=1 and b₃=1; ν=−3 maps to b₁=1 b₂=0 and b₃=1; ν=1 maps to b₁=0 b₂=0 and b₃=1; ν=2 maps to b₁=0 b₂=1 and b₃=0.

Next (when the input vector is represented in binary form), three cycles of binary MAC operation is performed. In a first cycle, the least significant bits of the input vector entries are provided optically as inputs into the crossbar array. So, for example, light with intensity ‘0’ is input into the topmost and bottommost input waveguide, and light with intensity ‘1’ is input into the two middle input waveguides. This light is treated by three photonic processing components each having a binary mixed-mode memory element holding a respective value for b₁, b₂ and b₃. So, in the first cycle, the output 1634 of the leftmost output waveguide, in response to input light represented by column vector [0;1;1;0] 1632, is 0*1+1*1+1*0+0*0=1; the output of the middle output waveguide, in response to input light represented by column vector [0;1;1;0], is 0*1+1*0+1*0+0*1=0; and the output of the rightmost output waveguide, in response to input light represented by column vector [0;1;1;0], is 0*1+1*1+1*1+0*0=2. This creates the output [1,0,2] as illustrated. This output is processed according to the weighted sum as in Equation (1). That is, an output value of ν=−2 is provided in the first cycle.

Similarly, in the second cycle, the output of the leftmost output waveguide, in response to input light represented by column vector [1;1;0;0], is 1*1+1*1+0*0+0*0=2; the output of the middle output waveguide, in response to input light represented by column vector [1;1;0;0], is 1*1+1*0+0*0+0*1=1; and the output of the rightmost output waveguide, in response to input light represented by column vector [1;1;0;0], is 1*1+1*1+0*1+0*0=2. This creates the output [2,1,2] as illustrated. This output is processed according to the weighted sum as in Equation (1). That is, an output value of ν=−4 is provided in the second cycle. Similarly, in the third cycle, using column vector [0;0;1;1] an output value of ν=3 is provided.

Finally, the output values provided by all three cycles are processed again using Equation (1). As mentioned above, the output values of the first, second and third cycles are −2, −4 and 3, respectively. These output values are treated respectively as variables, b₁=−2 b₂=4 and b₃=3 in Equation (1) to yield a final output value of −22. This final output value is provided as the result of the multiplication for this particular portion of the crossbar array. Other portions of the crossbar array are treated similarly.

Alternatively, the weight vector can be represented using multiple lower precision (e.g. 2-bit or 3-bit) mixed-mode memory elements as above, and the output values can be computed in a similar manner. The input vector can be represented using a multilevel, non-binary form. In this case, multiple cycles may be unnecessary.

Compared to high-precision analog devices, use of binary or low precision devices allows storing the weights with higher accuracy and also achieving high performance and energy efficiency, leading to substantial area and energy benefits. Our proposed electronic and mixed-mode electro-optical engine can be used for accelerating inference tasks for specific applications in which obtaining a prediction (even at reduced accuracy) in near real-time (ns delay) is essential and has the priority over obtaining a prediction with high accuracy with longer latency.

To summarize, embodiments of the present disclosure provide for an electro-optical mixed-mode memory element (cell). A change in optical characteristic (e.g. transmission) and electrical characteristic (e.g. resistance or its reciprocal, conductance) of the memory element is the result of the electrical switching of the device. The memory element can be read out both optically and electrically. This can facilitate the development of crossbar arrays well-suited for applications such as integrated optical switches, reconfigurable photonic circuits and photonic artificial neural networks.

Embodiments of the present disclosure may be implemented for artificial neural network training which involves an iterative cycle of signal propagation and weight update calculation operations. The neural network is exposed to a set of training data, in an iterative training scheme during which the weights are repeatedly updated as the network “learns” from the training data. The forward propagation occurs in optical domain and backward propagation in electrical domain.

Analog processing unit (APU) may be implemented to mitigate or eliminate the use of data converters and generate signals propagated by the neuron layers in the backpropagation operation and to perform the weight-update calculation operations. The analog processing unit may be further adapted to control the programming circuit to periodically program the PCM devices storing the weight value.

A custom analog memory architecture may be provided to remove or mitigate the time-consuming data movement between the architecture components and reduce (or eliminate) the use of data converters.

In some embodiments, a hybrid 2.5D or 3D SiP integration of CMOS-Mixed Mode Crossbar array-Si Photonics platforms may be employed, potentially resulting in a high-performance and rugged in a small form factor.

Embodiments of the present disclosure may be implemented for in-memory computing, neural network training, and matrix multiplication computing accelerators. Matrix multiplication accelerators may require changing both the input light and the contents of the mixed-mode memory elements dynamically. This may involve both high-bandwidth input intensity modulation and high-speed memory element updates.

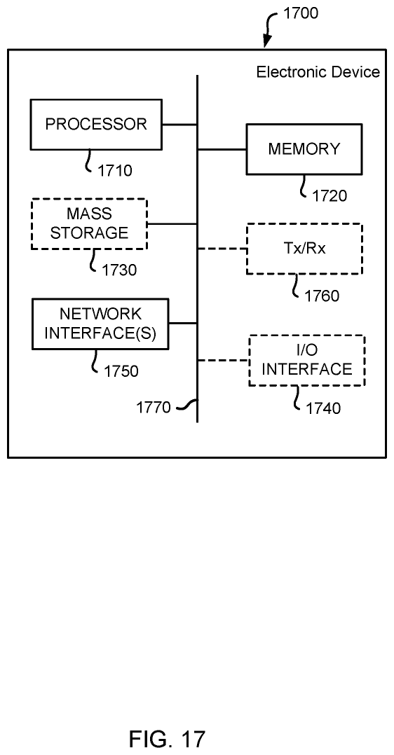

FIG. 17 is a schematic diagram of an electronic device 1700 that may act as a controller or interface for embodiments of the present disclosure as described herein. For example, network infrastructure devices, end-user computers, smartphones, physical machines or servers, or other computing devices can be configured as the electronic device. It is also noted that controllers directing operations of embodiments of the present disclosure may be microcontrollers or microprocessors which execute program instructions stored in memory, or other digital or analog circuitry, or a combination thereof.

As shown, the device includes a processor 1710, such as a Central Processing Unit (CPU) or specialized processors such as a Graphics Processing Unit (GPU) or other such processor unit, memory 1720, non-transitory mass storage 1730, I/O interface 1740, network interface 1750, and a transceiver 1760, all of which are communicatively coupled via bi-directional bus 1770. According to certain embodiments, any or all of the depicted elements may be utilized, or only a subset of the elements. Further, the device 1700 may contain multiple instances of certain elements, such as multiple processors, memories, or transceivers. Also, elements of the hardware device may be directly coupled to other elements without the bi-directional bus.

The memory 1720 may include any type of non-transitory memory such as static random access memory (SRAM), dynamic random access memory (DRAM), synchronous DRAM (SDRAM), read-only memory (ROM), any combination of such, or the like. The mass storage element 1730 may include any type of non-transitory storage device, such as a solid state drive, hard disk drive, a magnetic disk drive, an optical disk drive, USB drive, or any computer program product configured to store data and machine executable program code. According to certain embodiments, the memory 1720 or mass storage 1730 may have recorded thereon statements and instructions executable by the processor 1710 for performing any of the aforementioned method steps described above.

It will be appreciated that, although specific embodiments of the technology have been described herein for purposes of illustration, various modifications may be made without departing from the scope of the technology. The specification and drawings are, accordingly, to be regarded simply as an illustration of the disclosure as defined by the appended claims, and are contemplated to cover any and all modifications, variations, combinations or equivalents that fall within the scope of the present disclosure. In particular, it is within the scope of the technology to provide a computer program product or program element, or a program storage or memory device such as a magnetic or optical wire, tape or disc, or the like, for storing signals readable by a machine, for controlling the operation of a computer according to the method of the technology and/or to structure some or all of its components in accordance with the system of the technology.

Acts associated with the method described herein can be implemented as coded instructions in a computer program product. In other words, the computer program product is a computer-readable medium upon which software code is recorded to execute the method when the computer program product is loaded into memory and executed on the microprocessor of the wireless communication device.

Acts associated with the method described herein can be implemented as coded instructions in plural computer program products. For example, a first portion of the method may be performed using one computing device, and a second portion of the method may be performed using another computing device, server, or the like. In this case, each computer program product is a computer-readable medium upon which software code is recorded to execute appropriate portions of the method when a computer program product is loaded into memory and executed on the microprocessor of a computing device.

Further, each step of the method may be executed on any computing device, such as a personal computer, server, PDA, or the like and pursuant to one or more, or a part of one or more, program elements, modules or objects generated from any programming language, such as C++, Java, or the like. In addition, each step, or a file or object or the like implementing each said step, may be executed by special purpose hardware or a circuit module designed for that purpose.

Although the present invention has been described with reference to specific features and embodiments thereof, it is evident that various modifications and combinations can be made thereto without departing from the invention. The specification and drawings are, accordingly, to be regarded simply as an illustration of the invention as defined by the appended claims, and are contemplated to cover any and all modifications, variations, combinations or equivalents that fall within the scope of the present invention.

What is claimed is:

1. An apparatus comprising:
an input waveguide configured to propagate an input optical signal;
an output waveguide configured to provide an output optical signal;
a processing component comprising:
an input optical coupler operatively coupled to the input optical waveguide and configured to couple at least a portion of the input optical signal onto an optical processing pathway of the processing component;
a mixed-mode memory element:
located along the optical processing pathway and configurable to exhibit a persistent state which is programmable using a respective write control signal and which exhibits an electrical characteristic corresponding to the state and an optical property corresponding to the state; and
configured to manipulate said portion of the input optical signal according to the optical property of the persistent state to produce an output; and
an output optical coupler configured to receive the output of the mixed-mode memory element and couple said output onto the output waveguide in order to provide at least a portion of said output optical signal; and
an electrical readout circuit configured to electrically interact with the mixed-mode memory element to produce an electrical readout signal which varies with the electrical property of the mixed-mode memory element.

2. The apparatus of claim 1, wherein the write control signal is an electrical write control signal.

3. The apparatus of claim 1, wherein the mixed-mode memory element is an electro-optical plasmonics device.

4. The apparatus of claim 1, wherein the mixed-mode memory element comprises a phase change material that causes the persistent state based on the respective input electrical write control signal.

5. The apparatus of claim 4, wherein the electrical write control signal is an electrical pulse configured to change the persistent state according to a width, amplitude, or both width and amplitude of said electrical pulse.

6. The apparatus of claim 1, further comprising:
a readout device comprising a photodetector operatively coupled to the output waveguide, the photodetector configured to generate an output signal indicative of the output optical signal; and
a controller configured to:
cause an optical signal source to provide the input optical signal to the input waveguide, the input optical signal having an intensity which is set in response to a signal from the controller;
obtain the output signal from the readout device or cause other electronics to obtain the output signal from the readout device; and
operate the electrical readout circuit and obtain the electrical readout signal or cause the other electronics or further electronics to obtain the electrical readout signal.

7. The apparatus of claim 6 wherein the controller is further configured to cause the mixed-mode memory element to be programmed based on the output signal and the electrical readout signal.

8. The apparatus of claim 1, wherein the optical property of the mixed-mode memory element comprises a controllable optical transmittance by which an intensity of light making up said portion of the input optical signal is controllably adjusted, the apparatus configured to perform a multiplication between a first value represented using a power or amplitude of the input optical signal and a second value represented using the controllable optical transmittance, the multiplication comprising setting the power or amplitude of the input optical signal and adjusting said portion of the input optical signal according to the controllable optical transmittance.

9. The apparatus of claim 1, further comprising:
one or more additional output waveguides each configured to provide a further respective output optical signal;
one or more additional processing components, each comprising:
a further respective input optical coupler operatively coupled to the input waveguide and configured to couple a further respective portion of the input optical signal onto a further respective processing pathway of the additional processing component;
a further respective mixed-mode memory element:
located along the further respective processing pathway and configurable to exhibit a further respective persistent state which is programmable using a further respective write control signal and which exhibits a further electrical characteristic corresponding to the further respective persistent state and a further respective optical property corresponding to the further respective persistent state; and
configured to manipulate said further respective portion of the input optical signal according to the optical property of the further respective persistent state to produce a further respective output; and
a further respective output optical coupler configured to receive the further respective output of the further respective mixed-mode memory element and couple said output onto a different corresponding one of the additional output waveguides in order to provide at least a portion of the further respective output optical signal thereof, wherein the electrical readout circuit is configured to electrically interact with multiple mixed-mode memory elements, including the mixed-mode memory element and each further respective mixed-mode memory element of the one or more additional processing components, to produce the electrical readout signal.

10. The apparatus of claim 9, wherein the electrical readout signal is indicative of a multiply and accumulate operation in which different voltages are applied to different respective inputs of different ones of the mixed-mode memory elements, wherein said electrical characteristic and each said further electrical characteristic is an electrical resistance or conductance, the multiply and accumulate operation performed by reading electrical outputs of the mixed-mode memory outputs which vary in accordance with said voltages and said electrical resistance or conductance.

11. The apparatus of claim 9, further comprising a readout device comprising one or more balanced photodetectors, each of the balanced photodetectors operatively coupled to at least one respective pair of output waveguides including the output waveguide and the additional output waveguides, each of the balanced photodetectors configured to generate an output signal indicative of a difference between pairs of output optical signals provided thereto via said respective pair of output waveguides.

12. The apparatus of claim 1 further comprising:
one or more additional input waveguides each configured to propagate a further respective input optical signal; and
one or more additional processing components, each comprising:
a further respective input optical coupler operatively coupled to a different corresponding one of the additional input waveguides and configured to couple at least a portion of the further respective input optical signal thereof onto a further respective processing pathway of the additional processing component;
a further respective mixed-mode memory element:
located along the further respective processing pathway and configurable to exhibit a further respective persistent state which is programmable using a further respective write control signal and which exhibits a further electrical characteristic corresponding to the further respective persistent state and a further respective optical property corresponding to the further respective persistent state; and
configured to manipulate said further respective portion of the input optical signal according to the optical property of the further respective persistent state to produce a further respective output; and
a further respective output optical coupler configured to receive the further respective output of the further respective mixed-mode memory element and couple said output onto the output waveguide in order to provide a further respective portion of the output optical signal thereof,
wherein the electrical readout circuit is configured to electrically interact with multiple mixed-mode memory elements comprising the mixed-mode memory element and each further respective mixed-mode memory elements of the one or more additional processing components to produce a plurality of electrical readout signals including the electrical readout signal.

13. The apparatus of claim 12, wherein the electrical readout circuit comprises multiple sub-circuits, each sub-circuit being configured to electrically interact with a respective set of one or more mixed-mode memory elements, from the mixed-mode memory element and the further respective mixed-mode memory elements, said respective set consisting of mixed-mode memory elements operatively coupled to a same input waveguide, each sub-circuit thereby producing a corresponding electrical readout signal of the plurality of electrical readout signals, the corresponding electrical readout signal varying with combined electrical properties of said one or more mixed-mode memory elements.

14. The apparatus of claim 13, wherein each sub-circuit is configured is configured to implement a vector multiplication between a first respective vector represented by voltages applied to the set of one or more mixed-mode memory elements and a second respective vector represented by states of the set of one or more mixed-mode memory elements.

15. The apparatus of claim 14, wherein the multiple sub-circuits operate concurrently to produce the plurality of electrical readout signals, and wherein for each sub-circuit the first respective vector is a same vector.

16. The apparatus of claim 12, wherein different output optical couplers, of the output optical coupler and the further respective output optical couplers, are configured to couple different, non-overlapping bands of wavelengths onto the output waveguide, the output optical signal generated based on cumulative outputs of the processing components, the apparatus further comprising a readout device comprising a photodetector configured to generate an output signal based on total intensity of the output optical signal.

17. The apparatus of claim 1, further comprising:
a second output waveguide configured to provide a second output optical signal; and
a second processing component comprising:
a second input optical coupler operatively coupled to the input waveguide and configured to couple a second portion of the input optical signal onto a second processing pathway of the second processing component;
a second mixed-mode memory element:
located along the second optical processing pathway and configurable to exhibit a second persistent state which is programmable using a second respective input electrical signal and which exhibits a second electrical characteristic corresponding to the second persistent state and a second optical property corresponding to the second persistent state; and
configured to manipulate said second portion of the input optical signal according to the second optical property of the second respective persistent state to produce a second output; and
a second output coupler configured to receive the second output of the second mixed-mode memory element and couple said output onto the second output waveguide in order to provide at least a portion of the second output optical signal thereof, wherein:
the mixed-mode memory element is configured to modify an intensity of said portion of the input optical signal by a first factor, and the second mixed-mode memory element is a configured to modify an intensity of said second portion of the input optical signal by a second factor;
the electrical readout circuit is configured to electrically interact with the mixed-mode memory element and the second mixed-mode memory element to produce the electrical readout signal which varies with combined electrical properties of the mixed-mode memory elements and the second mixed-mode memory element; and
the apparatus is configured to photonically multiply a first value by a second value, the first value represented by an intensity of the input optical signal, the second value being a signed value represented by a difference between the first factor and the second factor.

18. The apparatus of claim 17, wherein:
the electrically interacting comprises:
electrically interacting with the mixed-mode memory element to produce a first electrical readout signal which varies with the electrical property of the mixed-mode memory element;
electrically interacting with the second-mixed mode memory element to produce a second electrical readout signal which varies with the second optical property of the second mixed-mode memory element; and
generating a difference between the first electrical readout signal and the second electrical readout signal.

19. The apparatus of claim 18, further comprising a balanced photodetector configured to receive the output optical signal and the second output optical signal, and to produce an output signal indicative of the difference between the first output optical signal and the second output optical signal.

20. A method comprising:
programming a set of mixed-mode memory elements of a crossbar array to represent values of a multi-component multiplier, each mixed-mode memory element configurable to exhibit a persistent state which is programmable using a respective write control signal and which exhibits an electrical property corresponding to the state and an optical property corresponding to the state;
providing a set of input optical signals to a set of input optical waveguides of the crossbar array, wherein each input waveguide is configured to propagate a respective input optical signal, the set of input optical signals indicative of a multi-component multiplicand to be multiplied by the multiplier, the crossbar array configured to cause the set of input optical signals to interact with the set of mixed-mode memory elements to generate output optical signals which are indicative of a result of multiplying the multiplier with the multiplicand;
monitoring a readout device configured to provide a set of electrical output signals indicative of the set of optical output signals as provided by a set of output waveguides of the crossbar array; and
operating an electrical readout circuit to electrically interact with the set of mixed-mode memory elements to produce one or more electrical readout signals which vary with the electrical properties of the mixed-mode memory elements.
